(19) United States
(12) Patent Application Publication
(10) Pub. No.: US 2019/0342356 A1
(43) Pub. Date: Nov. 7, 2019

(54) SELECTIVELY UPDATING A DYNAMIC MANIFEST FILE

(71) Applicants: Koninklijke KPN N.V., Rotterdam (NL); Nederlandse Organisatie Voor Toegepast-Natuurwetenschappelijk Onderzoek TNO, 's-Gravenhage (NL)

(72) Inventors: Emmanuel Thomas, Delft (NL); Lucia D'Acunto, Delft (NL); Ray Van Brandenburg, Rotterdam (NL); Mattijs Oskar Van Deventer, Leidschendam (NL)

(21) Appl. No.: 16/474,502

(22) PCT Filed: Jan. 2, 2018
(86) PCT No.: PCT/EP2018/050023

§ 371 Date: Jun. 27, 2019

(30) Foreign Application Priority Data
Jan. 2, 2017 (EP) 17150021.8

(51) Int. Cl. H04L 29/06; H04L 29/08; H04N 21/24

(52) U.S. Cl. CPC H04L 65/4092; H04L 65/105; H04N 21/2405; H04N 21/2404; H04L 67/02

(57) ABSTRACT

A method for selectively updating a dynamic manifest file is described, wherein the method may comprise: selecting one or more metadata elements of a manifest file used by a client, the one or more selected metadata elements being associated with a subset of representations of the set of representations defined in the manifest file; transmitting a request message identifying the selected one or more metadata, and, optionally, said manifest file identifier, to a network node, the request message being configured to trigger the network node to generate a response message on the basis of the information in the request message; and, receiving the response message from the network node, wherein the response message comprises: location information, preferably an URL or a part thereof, for retrieving a selectively updated version of the dynamic manifest file used by the client, wherein the selectively updated version only comprises new segment identifiers associated with the one or more selected metadata elements; or, wherein the response message comprises: update information, preferably a patch, configured to selectively update the dynamic manifest file used by the client apparatus, wherein the update information only comprises new segment identifiers associated with the one or more selected metadata elements.

### FIELD OF THE INVENTION

The invention relates to selectively updating a dynamic manifest file, and, in particular, though not exclusively, to methods and systems for selectively updating a dynamic manifest file, a client apparatus adapted for selectively updating a dynamic manifest file and a network node for generating information for enabling a client apparatus to selectively update a dynamic manifest file, data structures such as manifest files and/or patch data structures for enabling a client apparatus to selectively update a manifest file and a computer program product for executing such methods.

### BACKGROUND OF THE INVENTION

In order for a client apparatus to be able to retrieve media data comprising audio and/or visual content from a streaming server, the client apparatus needs to retrieve metadata specifying what content is available and where it can be found. Within the context of HTTP adaptive streaming (HAS), metadata may be provided to a client apparatus using a so-called manifest file, which in MPEG-DASH is referred to as a media presentation description (MPD). A manifest file may contain information about the availability and location of variations of the same content (i.e. different representations of same content e.g. different resolutions, different encoding types, different language and/or subtitle versions, etc.). Further, the manifest file may contain information about the type of the content the manifest file refers to, e.g. a live-streaming service (e.g. as in broadcasting) or video on-demand (VOD) service. Hence, the manifest file allows a client apparatus to select and retrieve the most appropriate version of the content that is available given the capabilities of the media processing device and/or the network or broadcast link.

In certain use cases the content of a manifest file may change in time and/or its size may be excessively large. For example, in section 5.4 of the MPEG DASH standard ISO/IEC FDIS 23009-1:2013(E) Part 1: “Media presentation description and segment formats”, it is described that for live-streaming services the MPD comprises metadata for signalling the client that the MPD is a dynamic MPD, which is regularly updated. The client regularly receives an updated version of the MPD from a server which publishes newly available MPD comprising metadata regarding the latest chunks or segments of all Adaptation Sets and Representations that are made available for streaming. When the client apparatus receives a new version of the MPD, it replaces the MPD the client is currently using (the old version of the MPD) with the new version of the MPD so that continuous playout of the live-stream can be guaranteed.

However, a client apparatus may be able to consume only a (small) subset of all the available content representations signalled in the manifest files. For instance, the device capabilities may not be suited for certain resolutions, codecs, colour schemes, audio settings, etc. that are signalled in the manifest file. In addition, a user may manually restrict the particular content/stream representations the user is interested in. For instance, a user may select (ultra) high-definition (U)HD content, English audio track and Italian subtitles. In such situation, transmitting a full new version of the manifest file every time an update is available results in an inefficient use of the limited download bandwidth available to a client. As a consequence, when a downlink is congested, the client apparatus may decide to switch to a lower quality and, in the worst case, stall.

This problem becomes even more eminent when using a HAS streaming protocol such as MPEG DASH for streaming spatially tiled video to a client. In spatially tiled video streaming applications video frames of a wide field of view (panorama) video, e.g. a live soccer match, are spatially divided in video tiles (“tiles”) and individual tiles can be selected and streamed as a tile stream to a client. Tiled streaming allows a user to “zoom” into a subpart (a region of interest or “ROI”) of the panorama live video stream by selecting the tiles within the ROI. This way, live video streaming of a ROI is possible without the need to transmit the media data of the whole panorama video. In such spatially tiled live-streaming applications, a large number of “alternative content” corresponding to the various spatial subparts or “tiles” of the different video resolutions should be periodically signalled in the manifest filed to the client. In tiled video streaming, the amount of Adaptations Sets and Representations in the manifest file may easily add up to a hundred or more. Hence, in tiled HAS applications manifest files can be considerably larger than those for traditional HAS applications wherein even a few manifest updates may result in large bandwidth waste and increase the likelihood of switching to a low video quality or stalling of the video rendering.

In the above-referenced MPEG DASH standard and the associated Guidelines for Implementations: DASH-IF Interoperatbility Points, Version 3 of Apr. 7, 2015, a mechanism is proposed for updating a live-stream MPD that is used by a DASH client on the basis of patches. To that end, a video streaming server may insert a so-called MPD patch in a segment box in one or more segments that are sent (“pushed”) in-band to client apparatuses. The MPD patch comprises metadata in the form of a set of instructions for replacing parts of a manifest file with information that is contained in the patch which represents the difference between the current version of the manifest file and the next version of the manifest file. Hence, the patch only contains the difference (“diff”) between subsequent manifest file versions thereby reducing the bandwidth consumption when compared to the conventional MPD update scheme for live streaming. Applying a patch to a certain version i of the MPD, will result in a new version j of the MPD, wherein MPD elements of the old version of the MPD are replaced with MPD elements in the patch. A PublishTime attribute in order to identify the different versions of an MPD.

Hence, in contrast with the conventional MPD update mechanism for live streaming wherein new versions of the full MPD are regularly sent to the client for replacing the MPD the client is currently using, the MPD patch mechanism only sends the difference between the current MPD (the MPD the client is currently using) and a new MPD to the client. Although the patch mechanism allows saving bandwidth by sending a patch in a segment box to the clients, the patch is sent to all clients which all have to update the current MPD by applying the patch even though the user is not interested in (a substantial part of) the new information in the MPD or even though the client is not capable of using (a substantial part of) the new information (e.g. because it cannot decode a particular codec or a process a certain video format, e.g. tiled video). Hence, although the MPD patch mechanism provides some improvement in terms of reducing bandwidth use, it is still inefficient in terms of resource usage as each client apparatus will have to apply the patches in order to generate new versions of the whole MPD even though the new information will not or cannot be used, thereby increasing the risk that the client is not being able to render the stream at the best possible quality, because bandwidth is wasted to received unnecessary MPD patches.

Hence, there is a need in the art for improved methods and systems that enable a client apparatus to modify one or more parts of a manifest file. In particular, there is a need in the art for improved schemes for selectively updating one or more parts of a manifest file whereby the parts that need to be updated are selected by the client apparatus.

### SUMMARY OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including a scripting language for web pages like JavaScript or PHP, an object oriented programming language such as Java™, JavaScript, Smalltalk, C++, Python or the like and conventional procedural programming languages, such as the “C” programming language or similar programming languages. The program code may execute entirely on the users computer, partly on the users computer, as a stand-alone software package, partly on the users computer and partly on a remote computer, or entirely on the remote computer or server. In the latter scenario, the remote computer may be connected to the users computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is an objective of the invention to reduce or eliminate at least one of the drawbacks known in the prior art. In particular, the patch update schemes in the disclosure aim to reduce the problems associated with the conventional schemes as e.g. described in the MPEG DASH specification for updating a manifest file.

In an aspect, the invention may relate to a method for selectively updating a dynamic manifest file wherein the dynamic manifest file being used by a client apparatus, preferably an HTTP adaptive streaming (HAS) client apparatus.

The dynamic manifest file being used by a client apparatus for retrieving segmented content, wherein the segmented content may comprising segments or chunks referenced by said dynamic manifest file. The manifest file may comprise one or more metadata elements, e.g. Periods, Adaptation Sets and/or Representations defining different representations (e.g. in terms of quality, codec, bitrate, viewing angle, spatial tiling, etc.) of the segmented content, wherein each representation may be associated with a plurality of segment identifiers, each segment identifier identifying a segment associated with a predetermined playout time. The dynamic manifest file may associated with a manifest file identifier, e.g. a file name.

In an embodiment, the method may comprise: the client apparatus selecting one or more metadata elements of the manifest file, the one or more selected metadata elements being associated with a subset of representations of the set of representations defined in the manifest file; and, the client apparatus transmitting a request message identifying the selected one or more metadata, and, optionally, said manifest file identifier, to a network node, the request message being configured to trigger the network node to generate a response message on the basis of the information in the request message; and, the client apparatus receiving the response message from the network node, wherein the response message comprises: location information, preferably an URL or a part thereof, for retrieving a selectively updated version of the dynamic manifest file used by the client, wherein the selectively updated version only comprises new segment identifiers associated with the one or more selected metadata elements; or, wherein the response message comprises: update information, preferably a patch, configured to selectively update the dynamic manifest file used by the client apparatus, wherein the update information only comprises new segment identifiers associated with the one or more selected metadata elements.

In an embodiment, one or more metadata elements selected by the client may be updated by removal and/or replacement of segment identifiers associated the one or more selected metadata elements and/or by removal and/or replacement of the one or more metadata elements themselves or of one or more of their “sub-elements” (i.e. metadata elements that are part of the selected one or more metadata elements), and/or by addition of one or more “sub-elements” to the selected metadata elements.

Hence, the invention provides schemes that allow a client apparatus to selectively update segment identifiers associated with specifically selected metadata elements (e.g. selected Periods, Adaptation Sets and/or Representations) of the manifest file used by the client apparatus so that after updating the selectively updated version only comprises new segment identifiers with respect to the selected metadata elements. Here, the term new segment identifier refers to a segment identifier that was not present in the dynamic manifest file before it was selectively updated. Here, the term selectively updating refers to the mechanism wherein the client apparatus selects one or more metadata elements for which it would like to receive update information. Hence, after applying the update the manifest file is only updated with respect to specifically selected parts.

To that end, the client apparatus is configured to select specific parts, e.g. one or more metadata elements, of a data structure defining a dynamic manifest file the client apparatus is currently using. The update process of a manifest file is limited to the part the client apparatus is actually interested in. This way the amount of information that needs to be exchanged between the client apparatus and a manifest file server can be substantially reduced, especially when dealing with large dynamic manifest files as e.g. known from tiled streaming. Additionally by limiting the updates to specific parts of the manifest file, a substantial reduction in the data processing and buffering can be achieved.

A dynamic manifest file, e.g. a Media Presentation Description (MPD) in MPEG DASH, refers to a manifest file that may be updated (either by replacing the full MPD using an MPD update request or by replacing one or more metadata parts of an MPD using a patch). For example, in MPEG DASH a live stream MPD may include an MPD attribute for signalling a client apparatus that the MPD is dynamic, i.e. changes over time.

The selected metadata elements, e.g. MPD elements such as Periods, Adaptation Sets, Representations and/or MPD attributes associated with codecs, resolution, etc., are sent by the client apparatus in a request message to a network node, e.g. a manifest file server. The manifest file server may be configured to generate new versions of a dynamic manifest file and make these new versions accessible (“publish”) for client apparatuses. For example, during a live streaming session, the manifest file server may continuously or regularly publish new versions of the manifest file wherein a new version includes new segment identifiers, e.g. URLs, associated with new segments that are available for playout by the client apparatus.

The request may trigger the manifest file server to generate information associated with the one or more selected metadata elements in the request message which is sent back to the client apparatus in a response message. On the basis of the information the client apparatus may update the manifest file it is using into a selectively updated dynamic manifest file by only updating the segment identifiers associated with metadata elements in the manifest file that are identified in the request.

In an embodiment, if the response message comprises update information, the method may further comprise: the client apparatus selectively updating the dynamic manifest file it is using on the basis of the update information, preferably the updating including: replacement of segment identifiers in the dynamic manifest file with new segment identifiers identified in the update information; and/or, addition of new segment identifiers, and optionally, one or more new metadata elements identified in the update information to the dynamic manifest file. Hence, new segments identifiers may be added to the dynamic manifest file that are associated with metadata elements, e.g. Period, Adaptation Sets and/or Representations, selected by the client apparatus. Further, if one or more new metadata elements, e.g. a Representation within an Adaptation Set within a new Period, are available, these new metadata elements and the associated new segment identifiers may be added to the dynamic manifest file. This way, manifest file can be updated without changing the structure, e.g. the tree structure, of the manifest file.

In an embodiment, if the response message comprises location information, the method may comprise: using the location information to a request a network node to transmit a selectively updated version of the dynamic manifest file to the client apparatus; the client apparatus receiving the selectively updated version of the dynamic manifest file and replacing the dynamic manifest file used by the client apparatus with the selectively updated version. Hence, in this embodiment, the selectively updated version of the dynamic manifest file may be generated in the network. For example, when receiving the request, the network node may start a server instance that is configured to generate and publish selectively updated versions of the dynamic manifest file. By supplying the client apparatus with the network address of the service instance, the client apparatus is able to request the selectively updated version and replace the dynamic manifest file it is using with the selectively updated version.

In an embodiment, the manifest file is configured as a Media Presentation Description, MPD, the metadata associated with the set of representations of the segmented content including one or more Periods; one or more Adaptation Sets; and/or, one or more Representations and wherein the client apparatus is a HAS client apparatus configured to support the MPEG-DASH protocol.

In an embodiment, the network node may be a manifest file server configured to generate new versions of the dynamic manifest file used by the client apparatus, each new version of the dynamic manifest file being identified by an identifier, preferably a time-based identifier associated with the publication of the manifest file version by the network node; or, a hash-based identifier determined on the basis of at least part of the content of the manifest file, preferably the hash value being a hash value according to the ETag scheme. Hence, in this embodiment, the network node is a manifest file server that regularly or periodically publishes new versions of the dynamic manifest file. The manifest file server may use these new version in order to construct update information, e.g. in the form of an update patch, if a client apparatus requests a partial update of the manifest file it is using.

In an embodiment, the method may further comprise the client apparatus storing one or more metadata element identifiers and version information in a memory, the stored one or more metadata element identifiers identifying one or more metadata elements that are selectively updated by said client apparatus, the version information being associated with one or more versions of the manifest file published by the network node, wherein the network node constructed the update information on the basis of the one or more published versions.

In an the request message and the response message are configured as HTTP messages, preferably the one or more metadata elements and, optionally, the manifest file identifier in the request message being configured as a URI query string in the HTTP message.

In an embodiment the request message and the response message may be configured as Server And Network Assisted DASH, SAND, messages; preferably the SAND request message being a SAND status message configured to send a request for a update of the dynamic manifest file to a DASH Aware Network Element, DANE.

Hence, in order to send an update patch, e.g. an update patch, in the body of this HTTP POST message, a new scheme may be defined, urn:mpeg:dash:schema:sandmessage:2017, which supports the new SAND status message: PersonalizedPatch. In an embodiment, the SAND status message may include one or more of the following parameters:

| Parameter | Type | Cardinality | Description |
|---|---|---|---|
| PersonalizedPatchList | object | 1 | Contains a list of elements forming the |
| | | | patch request |
| Personalized Patch | entry | 1 . . . N | Contains a patch request for a certain |
| | | | subpart of the MPD available at a certain |
| | | | version at the client |
| mpd | string | 1 | The name of the MPD for which a patch is |
| | | | requested |
| version | string | 1 | The version of the part of the MPD, for |
| | | | which the patch is requested, available at |
| | | | the client |
| xpath | string | 1 | The XPath (XML Path Language) indicating |
| | | | the part of the MPD for which the patch is |
| | | | requested |

In an embodiment, the SAND response message generated by the DANE may be configured as a PER message comprising the update information or location information. The PER message, PersonalizedPatchContent, may comprise the update information, including the patch. In an embodiment, the PER message may comprise one or more of the following parameters:

| Parameter | Type | Cardinality | Description |
|---|---|---|---|
| PersonalizedPatchContentList | object | 1 | Contains a list of elements forming |
| | | | the patch response |
| PersonalizedPatchContent | entry | 1 . . . N | Contains a patch for a certain |
| | | | subpart of the MPD available at a |
| | | | certain version at the client |
| mpd | string | 1 | The name of the MPD for which a |
| | | | patch is for |
| version | string | 1 | The version of the part of the MPD, |
| | | | for which the patch is provided, |
| | | | available at the client |
| xpath | string | 1 | The XPath (XML Path Language) |
| | | | indicating the part of the MPD for |
| | | | which the patch is for |

In an embodiment the dynamic manifest file may comprise an indicator, preferably an SAND indicator, for signalling the client apparatus that the network node supports SAND messages for requesting selectively updating one or more metadata elements of the dynamic manifest file.

In an embodiment, the one or more metadata elements may be selected on the basis of capability information of the client apparatus and/or capability information of a media processing device on which the client apparatus is implemented; or, wherein the one or more metadata elements are selected on the basis of user input, preferably on the basis of the input of a user interacting with a user interface of the client apparatus; or, wherein the one or more metadata elements are selected on the basis of metrics, preferably quality of service, QoS, metrics, generated by the client apparatus.

In an embodiment the one or more metadata elements may be selected in response to a trigger signal, preferably the trigger signal being generated on the basis of timer period, the timer period being defined in the manifest file, more preferably the timer period being set by an minumumUpdatePeriod attribute in the manifest file.

In an embodiment, the manifest file comprises manifest file server capabilities information, the manifest file server capabilities information signalling the client apparatus that the network node is adapted to receive a request message comprising at least the one or more selected metadata elements and, optionally, version information associated with the one or more selected metadata elements, the request message being configured to trigger the network node to generate update information associated with the one or more selected metadata elements in the request message.

The capability of a server to support update patch requests, information patch requests, or both, may be indicated in the MPD by means of adding a “personalized patch” element to the MPD (which may be placed directly under the root MPD element). In an embodiment, the MPD element of the personalized patch element may comprise the following parameters:

| Element | Description |
|---|---|
| PersonalisedPatch | If present, specifies the URI where |
| | personalised patch can be requested |
| @version | Specifies the version of the selective |
| | update mechanism supported by the |
| | server. Version “1.0” supports all |
| | capabilities described in the present |
| | document. |
| @type | If present, specifies the type of patch |
| | supported, which can either be “streaming” |
| | or “information”. |
| | If absent, it means that the server supports |
| | both types of patch. |

In an embodiment the location information may comprise address information, preferably an URL, associated with a network node that is configured to generate one or more selectively updated versions of the dynamic manifest file used by the client on the basis of the information in the request message.

In an aspect, the invention may relate to server apparatus comprising: a computer readable storage medium having computer readable program code embodied therewith, and a processor, preferably a microprocessor, coupled to the computer readable storage medium, wherein responsive to executing the first computer readable program code, wherein the processor is configured to perform executable operations may comprise:
receiving a request message identifying a manifest file identifier identifying a dynamic manifest file a client apparatus is using,
the dynamic manifest file being used by a client apparatus, for retrieving segmented content, said segmented content comprising segments referenced by segment identifiers of said dynamic manifest file, the manifest file comprising metadata elements associated with a set of representations of the segmented content, each representation being associated with a plurality of segment identifiers, each segment identifier identifying a segment associated with a predetermined playout time,
the request message further identifying one or more metadata selected by the client apparatus, the one or more metadata being associated with a subset of representations of the set of representations defined in the manifest file the client is using;
determining or receiving new segment identifiers associated with the one or more selected metadata;
forming a selectively updated version of the dynamic manifest file the client apparatus is using, the selectively updated version only comprising new segment identifiers associated with the subset of representations;
transmitting a response message to the client apparatus, the response message comprising location information, preferably an URL or a part thereof, for retrieving the selectively updated version of the dynamic manifest file;

In another aspect, the invention may relate to server apparatus comprising: a computer readable storage medium having computer readable program code embodied therewith, and a processor, preferably a microprocessor, coupled to the computer readable storage medium, wherein responsive to executing the first computer readable program code, wherein the processor is configured to perform executable operations may comprise:
receiving a request message identifying a manifest file identifier identifying a dynamic manifest file a client apparatus is using,
the dynamic manifest file being used by a client apparatus, for retrieving segmented content, said segmented content comprising segments referenced by segment identifiers of said dynamic manifest file, the manifest file comprising metadata elements associated with a set of representations of the segmented content, each representation being associated with a plurality of segment identifiers, each segment identifier identifying a segment associated with a predetermined playout time,
the request message further identifying one or more metadata selected by the client apparatus, the one or more metadata being associated with a subset of representations of the set of representations defined in the manifest file the client is using;
determining or receiving new segment identifiers associated with the one or more selected metadata;
forming update information, preferably a patch, configured to selectively update the dynamic manifest file used by the client apparatus, wherein the update information only comprises new segment identifiers associated with the one or more selected metadata elements;
transmitting a response message to the client apparatus, the response message comprising update information triggering the client apparatus to selectively the manifest file it is using.

In a further aspect, the invention may relate to a client apparatus, preferably an HTTP adaptive streaming (HAS) client apparatus, configured to selectively update a dynamic manifest file, the dynamic manifest file being used by a client apparatus, for retrieving segmented content, said segmented content comprising segments referenced by segment identifiers of said dynamic manifest file, the manifest file comprising metadata elements associated with a set of representations of the segmented content, each representation being associated with a plurality of segment identifiers, each segment identifier identifying a segment associated with a predetermined playout time, the dynamic manifest file being associated with a manifest file identifier, comprising: a computer readable storage medium having at least part of a program embodied therewith, the computer readable storage medium comprising the dynamic manifest file; and, a computer readable storage medium having computer readable program code embodied therewith, and a processor, preferably a microprocessor, coupled to the computer readable storage medium, wherein responsive to executing the computer readable program code, the processor is configured to perform executable operations comprising:
selecting one or more metadata elements of the manifest file, the one or more selected metadata elements being associated with a subset of representations of the set of representations defined in the manifest file;
transmitting a request message identifying the selected one or more metadata, and, optionally, said manifest file identifier, to a network node, the request message being configured to trigger the network node to generate a response message on the basis of the information in the request message; and,
receiving the response message from the network node,
wherein the response message comprises:
location information, preferably an URL or a part thereof, for retrieving a selectively updated version of the dynamic manifest file used by the client, wherein the selectively updated version only comprises new segment identifiers associated with the one or more selected metadata elements; or,
wherein the response message comprises:
update information, preferably a patch, configured to selectively update the dynamic manifest file used by the client apparatus, wherein the update information only comprises new segment identifiers associated with the one or more selected metadata elements.

In a further aspect, the invention may relate to a non-transitory computer-readable storage media comprising a dynamic manifest file for a client apparatus, preferably an HTTP adaptive streaming client apparatus, the manifest file comprising computer readable program code, the code comprising:
a manifest file version identifier, preferably the manifest file version identifier including a time parameter, more preferably a publishTime attribute for signalling the client apparatus the time at which the manifest file was published by a network node;
metadata elements associated with a set of representations of segmented content, each representation being associated with a plurality of segment identifiers, each segment identifier identifying a segment associated with a predetermined playout time; and,
server capabilities information, the server capabilities information signalling the client apparatus that the server is adapted to receive a request message from the client apparatus and to send a response message to the client apparatus, the request message comprising one or more metadata element identifiers of the manifest file the client apparatus is using, the one or more metadata being selected by the client apparatus, and a manifest file identifier of the dynamic manifest file used by the client apparatus, the request message being configured to trigger the server to generate update information for a client apparatus, the update information enabling the client apparatus to selectively update the dynamic manifest file used by the client apparatus or location information for enabling the client apparatus to retrieve a selectively updated version of the dynamic manifest file used by the client apparatus; and, to transmit the update information or location information in a response message to the client apparatus.

The invention may also relate to a program product comprising software code portions configured for, when run in the memory of a computer, executing any of the method steps described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 schematically depicts a media delivery system for streaming media data to a client apparatus according to an embodiment of the invention;

FIG. 2A-2C depict exemplary data structures of manifest files for use by a client apparatus according to an embodiment of the invention;

FIG. 3 depicts a client apparatus and a manifest file server according to an embodiment of the invention;

FIG. 4 depicts a flow diagram of a process executed by a patch client module according to an embodiment of the invention;

FIG. 5 depicts a flow diagram of a process executed by a patch server module according to an embodiment of the invention;

FIG. 6 depicts a sequence diagram for a patch request/response interaction between client and server according to an embodiment of the invention;

FIG. 7 depicts a composite patch according to an embodiment of the invention;

FIG. 8 schematically depicts a media delivery system for streaming media data to a client apparatus according to a further embodiment of the invention;

FIG. 9 depicts a block diagram illustrating an exemplary data processing system that may be used in as described in this disclosure.

### DETAILED DESCRIPTION

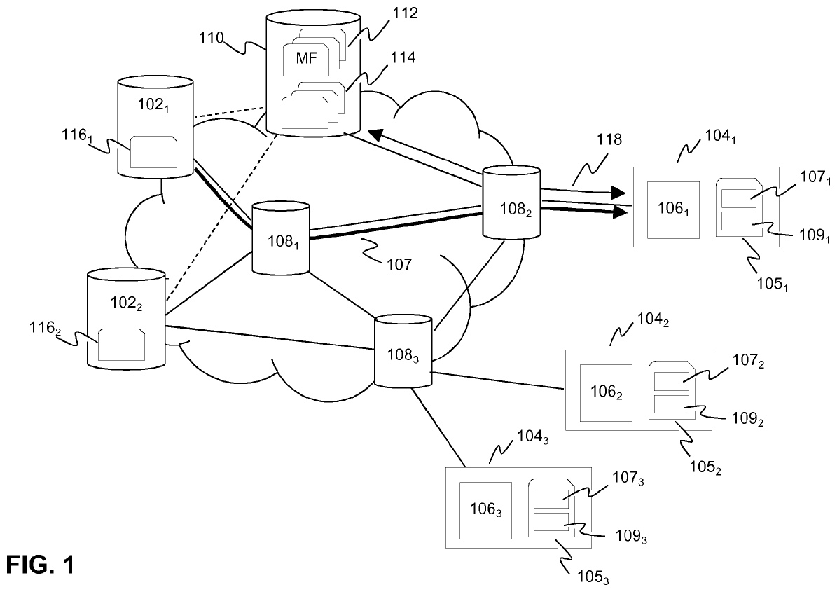

FIG. 1 schematically depicts a media delivery system for streaming media data to a client apparatus according to an embodiment of the invention. In particular, FIG. 1 depicts a media delivery system comprising one or more media sources 102_{1,2}, e.g. one or more media servers, configured for storing media data, e.g. video and/or audio data, on the basis of a predetermined data format and to stream the media data using a suitable streaming to media processing devices 104₁₋₃. A media processing device may generally relate to a content processing device, e.g. a (mobile) content play-out device such as an electronic tablet, a smart-phone, a notebook, a media player, a television, etc. In some embodiments, a media processing device may be a set-top box or content storage device configured for processing and temporarily storing content for future consumption by a media play-out device. A media processing device may comprise a client apparatus 106₁₋₃ configured for requesting media data from the one or more media servers in the network.

The media delivery system of FIG. 1 may be any type of delivery system for delivering content, e.g. an CDN, IPTV, etc. which may use different distribution techniques including unicast, multicast, broadcast and combinations thereof., etc. for transmitting media data to the client apparatuses. In particular, the media delivery system may be configured to delivery live-stream content and broadcast content, to client apparatuses using an adaptive streaming protocol such as an HTTP adaptive streaming (HAS) protocol. Examples of HTTP adaptive streaming protocols include Apple HTTP Live Streaming, Microsoft Smooth Streaming, Adobe HTTP Dynamic Streaming, 3GPP-DASH; Progressive Download and Dynamic Adaptive Streaming over HTTP and MPEG Dynamic Adaptive Streaming over HTTP [MPEG DASH ISO/IEC 23001-6]. These streaming techniques transfer (usually temporally) chunked data such as video and audio data over HTTP.

These streaming techniques transfer (usually temporally) chunked media data such as video and audio data over HTTP. A chunk might be referred to as a fragment (which is stored as part of a larger file) or a segment (which is stored as separate files). Chunks may have any playout duration, however typically the duration is between 2 second (e.g., Microsoft Smooth Streaming) and 10 seconds (e.g., Apple HTTP Live Streaming). A HAS client apparatus may render a video title by sequentially requesting chunks from the network, e.g. a content delivery network (CDN), and process the requested and received chunks such that seamless rendering of the video title is assured.

A chunk may be available in one or more quality representations (quality levels) thereby allowing a client apparatus to seamlessly adapt the quality of the video from one chunk request to the next, based on current network and device conditions. The manifest file may comprise a set of chunk or segment identifiers (usually in the form of one or more URLs) for determining network elements, e.g. media servers or network caches that are configured to transmit chunks or segments to client devices. (Part of the) chunks may be retrieved from a (transparent) cache residing in the network that lies in the path to one of these locations, or from a location that is indicated by a request routing function in the network. In Dynamic Adaptive Streaming over HTTP (DASH), an MPEG HAS standard, a manifest file may also referred to as the Media Presentation Description (MPD).

In an embodiment, the media delivery system may be configured as a DASH over broadcast system. Such system may comprise a network system for broadcasting segments to home devices that comprise an HTTP server configured to store the broadcasted segments. Some of the broadcasted segments may include an MPD or patches for MPDs. Client apparatuses may playout the segments by connecting to the HTTP server on the home device and sequentially request and receive segments from the HTTP server. Patches requested by the client apparatus may be sent via a separate communication channel using processes and functionalities described in this disclosure.

A media server may transmit media data 107 via one or more network nodes 108₁₋₃ (proxies, caches, etc.) to a client apparatus using an adaptive streaming technique, e.g. HAS streaming technique, that transfers chunked or segmented video over HTTP to client apparatuses that are implemented on the media processing devices. At the start of a live-streaming session, a client apparatus may be provided with an address or a URL of a network node 110, e.g. a manifest file (MF) server, which is configured to generate dynamic manifest files. The client apparatus may use the address or URL in order to request a manifest file 112 from the network node. The manifest file may comprise a set of chunk or segment identifiers (or information to determine such identifiers) and different (quality) representations of the chunks or segments associated with a media stream. The client apparatus may use chunk or segment identifiers to start requesting chunks by transmitting chunk request messages (e.g. HTTP request messages) to a media server 102_{1,2} and receive response messages (e.g. in the forms of HTTP response messages) comprising the requested chunks or segments as payload from a media server. As a dynamic manifest file only contains a set of the most recent segment identifiers the MF server will periodically publish a new dynamic manifest file for the client apparatus wherein the new manifest file comprises a new set of segment identifiers.

In this disclosure embodiments are generally described within the context of MPEG DASH however such embodiments may also be implemented on the basis of other streaming schemes. Hereafter, the terms “manifest file” and “MPD” (Media Presentation Description, the manifest file used in DASH) will be used interchangeably.

Once the set of segment identifiers in a dynamic manifest file is outdated (e.g. because all segments in the manifest file are requested), a new version of the dynamic manifest file is required. In that case, the client apparatus may request a new version of the dynamic manifest file from the MF server. Alternatively, instead of a client apparatus requesting a new version of the dynamic manifest file, the MF server may be configured to periodically push a new version of the dynamic manifest file to the client apparatus. Upon reception of the new version, the client apparatus may replace the outdated manifest file version with this new version so that continuous playout of the media data is guaranteed. The replacement of the manifest file with a new version of the manifest file may be referred to as an update of the dynamic manifest file.

In some situations, it may be advantageous to update the manifest files on the basis of the differences between subsequent versions of a manifest file. For example, the MPEG DASH specification describes a patch mechanism that allows a media server to provide an update of an MPD that is used by a DASH client apparatus by including an MPD patch 116_{1,2} in a segment box of a media segment transmitted to the client apparatus. The patch may contain metadata, e.g. instructions for the client apparatus and information that needs to be inserted in the manifest file, which—once applied to a certain MPD version i of the MPD - permits to obtain a further MPD version j. For example, if the BaseURL in the following live-streaming MPD:

<?xml version=“1.0” encoding=“UTF-8”?>
<MPD

xmlns:xsi=“http://www.w3.org/2001/XMLSchema-instance“
xmlns=“urn:mpeg:dash:schema:mpd:2011”
xsi:schemaLocation=“urn:mpeg:dash:schema:mpd:2011
DASH-MPD.xsd”
type=“dynamic”
minimumUpdatePeriod=“PT2S”
timeShiftBufferDepth=“PT30M”
availabilityStartTime=“2015-05-06T07:31:03”
minBufferTime=“PT4S”
publishTime=“2015-05-06T07:37:19Z”
profiles=“urn:mpeg:dash:profile:isoff-live:2011”>
<BaseURL>http://cdn1.example.com/sample.MPD</BaseURL>
<Period id=“1”>
...
</Period>

</MPD>

### EXAMPLE 1

MPD stored in the memory of a client apparatus needs to be changed to the address http://cdn2.example.com/sample.MPD, a patch may be inserted into one of the segments that is transmitted by the media server to the clients. An MPD that may be updated (either by replacing the full MPD or by replacing one or more parts of an MPD using a patch) may be referred to as a dynamic MPD. As shown in example 1 the MPD comprises an MPD attribute “type=dynamic” for signalling the client apparatus that the MPD is a dynamic MPD. A dynamic MPD may be used for live-streaming or broadcast situations. For example, the dynamic MPD in example 1 is used in a live-streaming session as signalled in the MPD to the client apparatus by the live-streaming attribute profile.

Using the patch mechanism, the streaming server may inform a client apparatus on an update of the manifest file by including patch information, metadata, in a segment box of a segment transmitted to the client apparatus. A patch may look as follows:

<?xml version=“1.0” encoding=“UTF-8”?>
<diff>

<replace sel=“MPD[@publishTime=“2015-05-

06T07:37:19Z”]/BaseURL/text( )[1]”>http://cdn2.example.com/sample.MPD</replace>

<replace sel=“MPD[@publishTime=“2015-05-06T07:37:19Z”]/@publishTime”>2015-05-

06T07:52:21Z</replace>
</diff>

### EXAMPLE 2

### Patch for Updating the Dynamic MPD of Example 1

When the client apparatus receives the segment containing the event message box, it may parse the segment and determine that it contains a patch and that the patch is to be applied to the current MPD version that is stored in the memory of the client apparatus. To that end, the patch comprises manifest version information that is indicative of the versions of a manifest file (in this example an MPD) to which the patch should be applied to. Here, the MPD the patch refers to is the MPD related to the content where the event message box transporting the patch was included.

The MPD version may be identified by a time parameter which may be indicative of a wall-clock time associated with the moment the version was made available (“published”) by a network server. For example, the time parameter may be the MPD publishTime attribute known from the MPEG DASH standard. For example, the MPD in the patch of example 2 comprises publish ime=“2015-05-06T07:37:19Z”, for identifying the MPD version to which the patch should be applied to (here the MPD of example 1).

Once the MPD version to which the patch refers has been identified by the client apparatus, the client apparatus may parse the patch and apply the patch to the MPD that is currently used by the client apparatus. The client apparatus may apply the patch by executing the instructions in the patch. After application of the patch of example 2 to the MPD of example 1, the updated MPD may look as follows:

<?xml version=“1.0” encoding=“UTF-8”?>
<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
type=“dynamic”
minimumUpdatePeriod=“PT2S”
timeShiftBufferDepth=“PT30M”
availabilityStartTime=“2015-05-06T07:31:03”
minBufferTime=“PT4S”
publishTime=“2015-05-06T07:52:21Z”
profiles=“urn:mpeg:dash:profile:isoff-live:2011”>
<BaseURL>http://cdn2.example.com/sample.MPD</BaseURL>
<Period id=“1”>
...
</Period>

</MPD>

### EXAMPLE 3

### MPD Updated on the Basis of the Patch of Example 2

As shown in example 3, the updated MPD has a new version number as indicated by the new publishTime attribute. This attribute was sent in the patch to the client apparatus.

Hence, from the above it follows that the patch mechanism may be used in order to instruct a client apparatus to update an MPD by including patch information (i.e. metadata) in a segment box which is sent to the client apparatus wherein the patch information comprises a difference (“diff”) between the current MPD and the next version of the MPD and instructions to modify the current manifest file on the basis of the difference. In the MPEG DASH standard, each time the patch is applied to the MPD, the MPD is updated according to the most recent MPD published by the MF server and the MPD version as indicated by the publishTime attribute is changed into the publishTime of the most recently published MPD. This way, the MPD patch mechanism may be used to periodically update a dynamic MPD during a live-streaming session thereby saving a considerable amount of bandwidth, since the DASH client apparatus only needs to receive the difference between versions i and j.

Although the patch mechanism known from the DASH standard allows saving some bandwidth by sending a patch for a manifest file update in a segment box, the client apparatus will still receive updates about parts of the manifest file the user is not interested in or cannot use, while still incurring the risk of not being able to view the stream at the best possible quality and the risk of downloading content (manifest updates) which will not be used.

In this disclosure methods and systems are described for selectively updating only a subset of the set of segment identifiers in the dynamic manifest file a client application is using. The subset of segment identifiers is associated with one or more parts of a dynamic manifest file selected by the client apparatus.

The schemes enable a client apparatus to select specific parts, e.g. one or more metadata elements, of the manifest file it is currently using, e.g. MPD elements such as Periods, Adaptation Sets, Representations and/or MPD attributes associated with codecs, resolution, etc., and to request a network node (e.g. a manifest file server that is configured to generate (“publish”) new versions of a dynamic manifest file) to send new segment identifiers associated with the selected one or more metadata elements. The new segment identifiers may be sent to the client apparatus in the form of a “personalized” patch that is specifically generated for the client apparatus. Alternatively, the network node may start a server instance which is configured to generate a selectively updated version of the dynamic manifest file used by the client, wherein the selectively updated version only comprises new segment identifiers associated with the parts that are selected by the client apparatus. The network node further sends a response message to the client apparatus wherein the response message comprises location information, e.g. an URL, for retrieving a selectively updated version of the manifest file.

The client apparatus may trigger a request for selectively updating the manifest file in response to the needs and/or capabilities of the client apparatus or the media processing device in which the client apparatus is implemented and/or the user the client apparatus is using.

As will be described hereunder in more detail, a client apparatus 106₁₋₃ associated with a media processing device 104₁₋₃ may be configured to determine and/or select one or more specific parts 107₁₋₃, 109₁₋₃, e.g. one or more metadata elements (e.g. MPD elements such as Periods, Adaptation Sets, Representations and/or MPD attributes associated with codecs, resolution, etc.) of the manifest file 105₁₋₃ it is currently using and to request an update for these identified parts of the manifest file. Such part of a manifest file may hereafter be referred to as a manifest file part or one or more metadata elements of a manifest file. In case of MPEG DASH, a manifest file part or an MPD part may e.g. include one or more elements of an MPD (e.g. one or more Periods, Adaptation Sets and/or Representations and/or attributes used in an MPD).

In order to enable modification of manifest file parts, the client apparatus may comprise one or more functions, e.g. timer functions, to trigger a request for modification of a manifest file part, e.g. by requesting a modification patch.

The client apparatus may request to selectively update part of the dynamic manifest file it is using (i.e. one or more metadata elements of a manifest file) so that the client apparatus is able to continuously access streaming content the media processing device may be interested in (or restricted to). As will be described hereunder in more detail, the request for selectively updating a dynamic manifest file (hereafter referred to as modification request) can also be triggered by other means, e.g. capability information of the client apparatus or the video processing apparatus in which the client apparatuses are implemented, user input via a user interface and/or metrics, e.g. Quality of Services (QoS) metrics, generated by the client apparatus and/or network elements.

The request may be sent to a network node, e.g. a server 110 in the network. The request may include information about metadata elements in the manifest file which the client apparatus would like to update. In this application, the term update may refer to replacement, addition and/or deletion of one or more metadata elements identified in the request.

The server receiving the request may be configured to use the information in the request in order to determine information which enables a client apparatus to generate or receive a selectively updated.

In an embodiment, the request may include information identifying one or more manifest file parts (e.g. one or more metadata element identifiers identifying the one or more metadata elements) of the manifest file which the client apparatus would like update. Further, in an embodiment, the request may further include one or more version IDs of the manifest file(s) associated to the manifest file parts that the client apparatus is currently using.

The server may generate update information on the basis of the information in the request. In an embodiment, update information may include a patch 114 comprising instructions for the client apparatus to update the segment identifiers associated with metadata elements of the manifest file that were selected by the client apparatus. Applying the patch to the dynamic manifest file the client apparatus is using will only update segment identifiers that are associated with specific metadata elements in the manifest file.

The server may construct the updated information on the basis one or more versions of a manifest file that was identified in the request. The client apparatus may apply the patch to the manifest file it is currently using. In an embodiment, a response comprising a patch may comprise one or more manifest file version IDs which were used by the server in the construction of the patch.

Further, in an embodiment, the response may comprise one or more manifest file version identifiers for identifying the versions of the parts in the manifest file to which the patch should be applied to.

In order to discover new features about the streaming content without the need to download all the information that is required to stream them, a client apparatus may be configured to request a MF server for information about the possibilities of updating one or more selected metadata elements of a manifest file (e.g. different Representations in terms of different codecs or resolutions of the same content), and/or new Adaptation Sets (e.g. newly available subtitles). Such request may be referred to as an information request or in short an information request. The server may send the requested information as an “information patch” to the client apparatus.

The update patch and information patch are examples of so-called “personalized” patches. The personalized patch scheme described in this disclosure enables a client apparatus to construct an update request or an information request that is specifically composed for the client apparatus, thus minimizing the risk that the client apparatus will download data (in particular data associated with manifest updates) that are not relevant for the client apparatus.

A client apparatus may subsequently update the segment identifiers associated with the one or more manifest file parts of a manifest file it is using on the basis of the update information in the response message. For example, it may apply a patch to its manifest file in order to update the segments identifiers associated with one or more metadata elements in the manifest file. For example, it may replace metadata elements in the manifest file with more recent versions of these metadata elements originating from more recent versions of manifest files published by the MF server. Hence, after applying a patch the manifest may comprise different metadata elements and associated segment identifiers originating from different manifest files published by the MF server.

In order to keep track of the different updates of different metadata elements in the manifest file, the client apparatus may comprise a version table which lists the version IDs of the manifest files that are used by the MF server in constructing update information. For example, the version table may comprise a manifest file version ID associated to the full manifest file originally fetched by the client apparatus and one or more version IDs of the one or more manifest file versions that were used for modifying one or more parts (one or more metadata elements) in the manifest file originally fetched by the client apparatus.

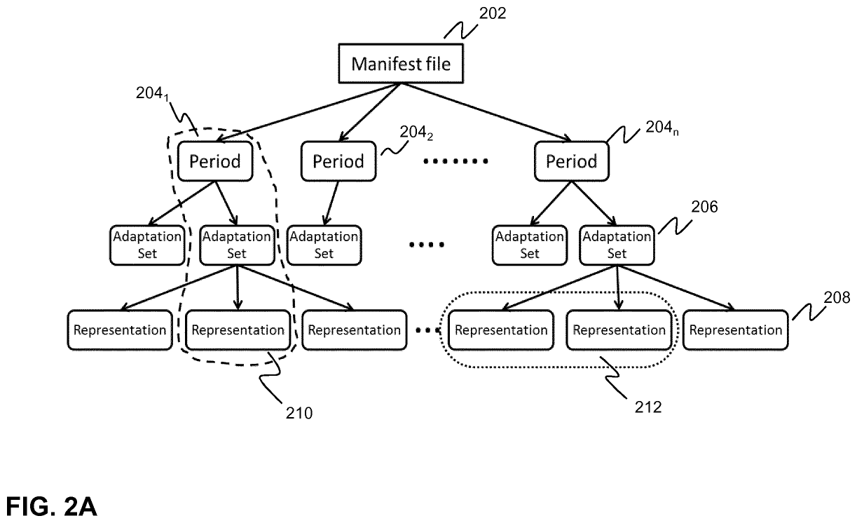

Hereunder, a more detailed description of the various processes, functions and data formats of the personalized patch request schemes according to the invention is provided. FIG. 2A-2C depict exemplary data structures of manifest files for a client apparatus according to an embodiment of the invention. In particular, FIG. 2A depicts an exemplary data structure of a dynamic manifest file that may be used in an HTTP adaptive streaming session between a client apparatus and a media server. In particular, FIG. 2A depicts an example of an MPEG-DASH type data structure 202, usually referred to as an MPD, comprising different metadata elements, which may include one or more Periods 204₁₋ₖ, Adaptation Sets 206₁₋ₙ and/or Representations 208₁₋ₙ.

Additionally, the metadata elements may include attributes used in the MPD (not shown). The MPD may have a hierarchal structure, for example an XML tree structure comprising a root element 202 and branch elements 204₁₋, 204₂, . . . , 204ₙ that are children from the root element.

A Period element may describe part of a video content with a start time and a duration. Each Period may be associated with one or more Adaptation Sets 206₁₋ₘ elements wherein an Adaptation Set element may be associated with a particular media data set, e.g. video and/or audio. Adaptation Sets may also be related to other types of data such as subtitles or metadata. Each Adaptation Set may be associated with one or more Representations 208₁₋ₙ. A Representation element may relate to the same or similar content but encoded in different ways thereby allowing e.g. support for different codecs (AVC/H.264, H.265, VP8, VP9, HEVC, etc.). Each Representation may be associated with segment identifiers for identifying segments that can retrieved by the client apparatus. Hence, the MPD defines a set of representations of content, wherein each representation is associated with segment identifiers. As the MPD is a dynamic MPD, e.g. an MPD describing live-streaming content, the segment identifiers need to be replaced on a regular basis with new segment identifiers that are made available by a manifest file server in the network.

As described with reference to FIG. 1, a client apparatus according to this disclosure may request an update of one or more selected parts of a dynamic manifest file, wherein the one or more selected parts is associated with a subset of representations of the set of representations defined in the MPD. Such request may be referred to as an partial update of a manifest file. For example, in an embodiment, a client apparatus may select one or more metadata that are vertically linked in the tree structure (i.e. an update of metadata elements of an MPD sub-tree) or one or more metadata of the same hierarchy in the MPD tree structure (i.e. an update of a specific metadata element or attribute across different Periods, Adaptation Sets and/or Representations in the manifest file). A set of vertically organized metadata elements 210 may comprise e.g. a Period, one or more Adaptation Sets associated with the Period, and one or more Representations associated with one or more of the one or more Adaptation Sets. Similarly, a set of horizontally organized metadata elements 212 (e.g. one or more Representations as depicted in FIG. 2A). More generally, a client apparatus according to this disclosure may request selective update of segment identifiers associated with one or more vertical metadata elements and/or horizontal metadata elements in a MPD tree structure. Although the selective update scheme is described within the context of MPEG DASH, the invention is not limited thereto. The invention may be applied to any type of adaptive streaming protocol that uses a dynamic manifest file data structure to request media data (e.g. in the form of video segments or chunks) from media delivery system.

FIG. 2B and 2C depict exemplary data structures of manifest files for use by a client apparatus according to an embodiment of the invention. For example, a client apparatus may start with a dynamic MPD that initially only identifies segments associated with Representations and Adaptation Sets of Period 1 as shown by the first subtree structure 216 of the MPD shown in FIG. 2B. A client apparatus supporting the personalized patch scheme may then determine that it is only interested in Adaptation Set 2 and Representation 1 within Period 1 and starts rendering video on the basis of segments associated with Representation 1. Then, after some time, the client apparatus may request a selective update of the MPD in order to obtain the next Period, Period 2. In that case, the client apparatus may construct a request that is configured to only request an update containing Representation 1 within Adaptation Set 2. To that end, the request may comprise the MPD elements Adaptation Set 2 and Representation 1 in order to signal the manifest file server that the client apparatus would like to selectively update the manifest file it is using with respect to the Adaptation Set 2 and Representation 1.

When the client apparatus sends the request to the manifest file server, the most recent version of the MPD may have an XML tree structure comprising a second subtree structure 218 associated with Period 2. As shown in FIG. 2B Period 2 includes two Adaptation Sets, Adaptation Set 1 comprising Representation 1 and Adaptation Set 2 comprising Representation 1 and Representation 2, wherein the client apparatus is only interested in a “subtree” 220 of the MPD 214.

The server may use the information in the request in order to construct an update patch for selectively updating the MPD the client apparatus is using so that only the part associated with Adaptation Set 2 and Representation 1 is updated. In this case the update patch may include instructions for the client apparatus to add metadata elements 226 associated with Representation 1 of Adapation Set 2 and Period 2, including new segment identifiers, to the MPD it is using thereby forming a selectively updated MPD 222 as depicted in FIG. 2C. When the patch is applied, Representation 1 in Adaptation Set 2 of Period 2 comprises an xlink so that the selectively updated data structure may be resolved by the client apparatus. Hence, as illustrated by FIG. 2A-2C, the personalized patch scheme of the invention allows a client apparatus to selectively update the dynamic MPD. This way, “a personalized MPD”, is formed which is specially adapted to the needs of the client apparatus.

From FIG. 2A-2C it follows that the update patch is applied before resolving any xlink in the XML tree structure. After the patch has been applied, the requirement is that the tree structure of the resulting MPD at the client apparatus is “parse-subtree identical”. This means that all the elements in the tree structure of the selectively updated MPD at the client apparatus are at the same position in tree structure of the MPD at the server which is used for constructing the patch. Hence, a dynamic manifest file may be partially updated by removing and/or adding Representations, Sub-Representations, or Adaptation sets by means of a personalized patch, so that the thus modified dynamic MPD is still “parse-tree identical” before any xlink resolution to the MPD that would have been retrieved at event time.

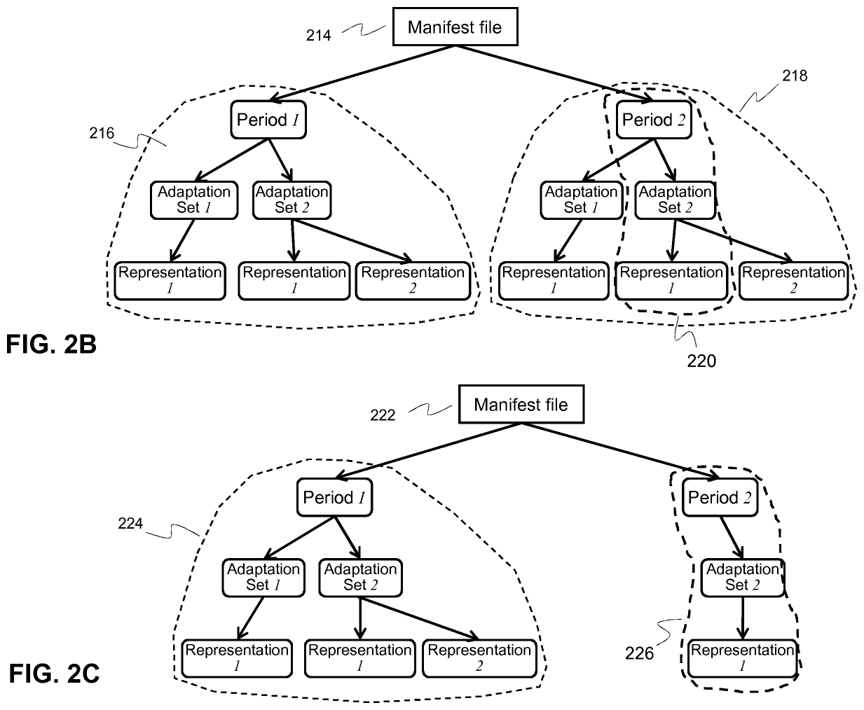

FIG. 3 depicts a client apparatus and server apparatus according to an embodiment of the invention. In particular, FIG. 3 depicts a client apparatus 302 comprising a HTTP adaptive streaming (HAS) client 304 configured to request and receive media data (e.g. audio-video (NV) data) that are transmitted in segments or chunks to the client apparatus. The HAS client may send request messages 305, e.g. HTTP requests, for media segments to one or more network nodes (not shown) on the basis of information in a manifest file (MF) 308 that is stored in a memory 309 of the client apparatus. In response to the request messages, the network node may transmit the requested segments to the client apparatus which may receive the segments, buffer the media data in the segments, decode the media data and render the decoded media data on a display.

The client apparatus may comprise a MF requester module 310 that is configured to communicate with a MF sender module 312 in a manifest file (MF) server 314. The MF sender module may be configured to send a new version of a manifest file to the client apparatus in response to a request of the MF requester module. The server and client apparatus may be part of a media distribution system as described with reference to FIG. 1.

The MF server module may be configured to communicate with a database 315 (hereafter referred to as a MF database) comprising different versions of a manifest file 316₁₋ₙ associated with a video title (i.e. a specific video content) or information for constructing different versions of a manifest file. To that end, a manifest file may be associated with manifest file version ID 319₁₋ₙ. The MF server may store different versions of the manifest file and determine a patch for enabling a client apparatus to update the manifest file it is using on the basis of the difference(s) between two or more (stored) manifest file versions. Alternatively, and/or in addition, the database may store the differences (“diffs”) between subsequent versions of a manifest file and use the differences for constructing patches for a client apparatus.

If the client apparatus receives a new manifest file, a MF replacer 317 may be triggered to replace (overwrite) the whole manifest file stored in the memory of the client apparatus with the retrieved manifest file. Here, the manifest file may be stored in the memory using a data format, e.g. an XML data format, that enables the HAS client to efficiently parse and process the information in the manifest file.

Further, the client apparatus may be configured to update a dynamic manifest file stored in the memory on the basis of a patch mechanism known from the MPEG DASH standard wherein patches may be “pushed” to the client apparatus by inserting a patch in one of the segments that are transmitted during the streaming process to the client apparatus. A patch client module 318 in the client apparatus may be configured to monitor for patch information that the client apparatus receives (e.g. received by the HAS client in segments and/or over a separate communication channel).

When the HAS client receives patch information, e.g. a segment comprising a segment box (which may be referred to as an “event message box”) with patch information, a patch integrator 304 may apply the patch to the manifest file, e.g. parse the patch information and execute the instructions in the patch information in order to update the stored manifest file so that is identical to the most current version of the manifest file as published by the MF server. During the update, the client apparatus may change the version identifiers of the manifest file into the version identifier as provided in the patch.

The patch may comprise an identifier for identifying the version of the manifest file to which the patch should be applied. The version of a manifest file may be identified by a publishTime attribute. One or more instruction messages in a patch may instruct the patch integrator 304 to identify information parts (metadata elements) in the stored manifest file and to replace the identified information parts with new information parts in the patch information. This way one or more parts (one or more metadata elements) of the manifest file may be updated on the basis of the information in the patch. The patch process allows for example insertion of a new URL (e.g. a BaseURL attribute) or replacement of old URL with a new URL that points to a location of a new network node that is capable of transmitting certain (media) segments to the client apparatus.

Patches may be sent to the client apparatus in segments comprising an event message box. To that end, a patch sender 328 in the patch server module 326 may be configured to transmit patch information to the patch client module 318 in order to update the dynamic manifest file stored in the memory of the client apparatus. When the instructions in the patch are successfully executed, the client apparatus may change the version number of the updated manifest file by changing the publishTime attribute.

In addition to the patch functionality known from the MPEG DASH standard, the patch client module 318 may comprise a patch initiator 324, a patch handler 322, and a patch requester 320. In some embodiment, the patch client module may further comprise a version table 306 that is managed by a version management processor (not shown) in the patch handler.

As will be described hereunder in more detail, these functions enable the patch client module to select one or more manifest file parts 307₁₋ₙ, i.e. one or more metadata elements, in the manifest file 308 for which the client apparatus would like to request an update (e.g. replacement of the one or more selected metadata elements by a new version of these metadata elements, addition of one or more metadata elements or removal thereof); and, to construct a request message for a network node, e.g. a server, which is configured to receive and process the request and to send information a response message back to the client apparatus.

In an embodiment, the response message may comprise update information, e.g. in the form of an update patch, configured to selectively update the dynamic manifest file used by the client apparatus, wherein the update information may comprise new segment identifiers associated with the subset of representations. The new segment identifiers may be retrieved from new versions of the manifest file that are regularly published by a manifest file server. Alternatively, in another embodiment, the response message may comprise location information, e.g. in the form of an URL or a part thereof, for retrieving a selectively updated version of the dynamic manifest file used by the client, wherein only the subset of representations are updated with new segment identifiers.

Hence, the client apparatus according to the invention is able to select one or more parts of a manifest file, wherein the one or more parts are associated with a subset of the set of representations identified in the manifest file, and to request a server for sending information, such as an update patch, enabling the client apparatus to only update segment identifiers that are associated with the one or more selected parts of the manifest file. This way, the client apparatus and the server enable personalized updates of segment identifiers associated with selected metadata elements in the database structure of the manifest file, i.e. updates that are specifically requested by a particular client apparatus or user of the client apparatus.

A client apparatus may use the update scheme in order to regularly update the manifest file on the basis of differently selected metadata elements. Hence, after a number of updates the manifest file used by the client apparatus may comprise different parts that were updated on the basis of different patches, wherein the different patches where constructed on the basis of different versions of the manifest file as published by a manifest file server.

In order to keep track of the different manifest file parts that were updated on the basis of different update patches, in one embodiment, the patch client module may comprise a version management processor that is configured to maintain a version table 306 that is stored in the memory of the client apparatus. The version table may identify one or more manifest file parts 307₁₋ₙ (metadata element identifiers identifying metadata elements in the manifest file) of the manifest file which were updated on the basis of one or more versions of the manifest file 308 using the personalized patch mechanism. A manifest file server may derive new segment identifiers associated with one or more selected metadata elements from new versions of the manifest file published by the manifest file server.

The information in a response may include the version identifiers 305₁₋ₙ of new versions of the manifest file which were used by the manifest file server to construct the modification information. This way, the client apparatus is capable of determining which version of the manifest file published by the manifest file server was used for updating a metadata element of the manifest file identified in the version table. Every time one or more manifest file parts of the manifest file are updated on the basis of the update information, e.g. a update patch, the version management processor updates the version table so that the client apparatus is able to keep track of the content of the selectively updated dynamic manifest file. When a patch requester 320 of a patch client module 318 sends a request message to the patch server module 326, the patch server module will generate a response message for the patch client module. The body of the response may comprise different types of personalized patches, e.g. an update patch and/or an information patch. Alternatively, the response may comprise complete a manifest file or it may be empty.

In an embodiment, in case the response messages comprises a update patch, the client apparatus may send the patch to a patch integrator module 304 that is configured to apply the patch to the data structure representing the manifest file as stored in the memory of the client apparatus. In an embodiment, in case the response comprises an information patch, the client apparatus may analyse whether any of the new metadata elements that are published by the manifest file server and signalled to the client apparatus should be downloaded.

If a client apparatus has received a dynamic manifest file, (i.e. a manifest file that can change over time), it may activate the patch client module 318 which is configured to decide if, when and what patch to request; to send a request message; and, to decide how to handle the response message.

The patch initiator module may be configured to trigger a partial update associated with a predetermined part (one or more metadata elements selected by a client apparatus) of the manifest file data structure. The patch initiator may receive different trigger signals for triggering such partial update. In an embodiment, the patch initiator module 324 may use one or more timers for generating a trigger signal.

In particular, the patch initiator module in the patch client module may comprise one or more timers for triggering the client apparatus to send a request for an update patch or an information patch associated with one or more metadata elements in the data structure of the manifest file. In an embodiment, a timer for a request for selectively updating metadata elements of the data structure of a manifest file may be set to the value of the “minumumUpdatePeriod” attribute of the MPD as known from the MPEG DASH standard. In a further embodiment, the timer for the request of an information patch may be set to a value not smaller than the “minumumUpdatePeriod” attribute of the MPD (for example twice the value of it).

In further embodiment, the patch initiator module may be configured to trigger the transmission of an update patch on the basis of other information. For example, in an embodiment, one or more metadata elements in a dynamic manifest file data structure, e.g. an XML data structure, may be selected by the client apparatus on the basis of capability information of the client apparatus or the capabilities of the media processing device in which the client apparatus is implemented. For example, if the media processing device is not capable of handling a certain codec, e.g. the HEVC codec, it may select Adaptation Sets and/or Representations associated with codecs other than HEVC, that are supported by the media processing device, e.g. the AVC codec, in order to request an update patch for updating the selected MPD elements with newly produced segments.

In another embodiment, the client apparatus and the image processing apparatus may not only support 2D spatially tiled video but also 360 degree or omnidirectional spatially tiled video for e.g. virtual or augmented reality applications. In that case, if the video content is also offered as 360 degree or omnidirectional spatially tiled video, the client apparatus may request an update patch for adding segment identifiers associated with Adaptation Sets, Representations and/or associated attributes to the MPD so that after applying the patch, the user may also render the video using a head mounted device.

In a further embodiment, the selection of the one or more metadata elements in a dynamic manifest file data structure may be based on user input. For example, a user interface may be configured to allow a user to interact with a user interface of the client apparatus so that certain user settings can be selected, e.g. subtitles, audio settings, etc. The client apparatus may use the user input in order to select certain metadata elements in the manifest file and send the selected metadata elements in an request to a manifest file server. The server may send a response comprising which can be used by the client apparatus to generate or retrieve a selectable updated manifest file that is updated in accordance with the selected preferences.

In yet a further embodiment, the selection may be based on metrics. For example, one or more parts of a dynamic manifest file may be selected on the basis of metrics generated by the client apparatus or metrics received by a client (e.g. metrics generated by a network element). For example, the client apparatus may be configured to measure quality of services (QoS) metrics and use these metrics for selecting one or more MPD attributes so that the bandwidth requirements for the content signalled in the MPD is within the bandwidth range that is available to the client apparatus.

Additionally, in yet a further embodiment, a patch may be triggered if a problem is detected by the client apparatus and/or signalled to the client apparatus. Such problems may include (but are not limited to):
an attempt to fetch a new segment fails (probably due to a URL change)
the last segment in the MPD has been retrieved (probably meaning that the list of segments is not up to date with the newly produced ones)

Depending on the situation, instead of a partial update, the patch initiator may decide to trigger the client apparatus to send a request for a (whole) new manifest file. In that case, the patch client module may activate the MF requester 310 in order to send a MF request to the server. When a new version of the manifest file is received, the MF replacer 317 may overwrite the old version of the manifest file that is stored in the memory 309 with the new version. In an embodiment, the patch handler 322 may in that case update the version table by removing the version information associated with the old manifest file and storing the new manifest file version ID 305₁₋ₙ.

In a further embodiment, the patch initiator module may decide to trigger the client apparatus to send a request for an update patch in response to an information patch. For example, if an information patch reports the availability of a new metadata element in the manifest file, e.g. a new HD representation of the content, it may request an update patch for updating the manifest file with respect to the new representation so that it includes information (e.g. one or more segment identifiers) URLs, that enables the client apparatus to request the HD variant of the video it is rendering.

The patch initiator module 324 may trigger a patch requester module 320 to construct a desired request message and to send the request message to a server that is configured to receive and process the request. The patch requester module may be implemented as an HTTP client function. The patches may be sent by a MF server to the client apparatus over an HTTP-based a communication channel. Alternatively, in another embodiment, the communication channel may be based on a WebSocket protocol or on a Server and network assisted DASH (SAND) protocol.

Once the patch initiator module has initiated the process and selected the manifest file parts that need to be updated, it will instruct the patch requester module 320 to send the constructed request for updating the selected manifest file parts (metadata elements) of the manifest file to the server. For this purpose, the patch requester 320 may comprise an HTTP interface that is configured to communicate with an HTTP interface of the patch request receiver 332. Once a response is obtained from the server, the patch requester module will parse it and dispatch the parsed information to the patch handler module 322. Specific formats of HTTP request and response messages for streaming and information patches are described hereunder in more detail.

The body of the response message originating from the patch server module may comprise an update patch, an information patch, a manifest file or may be empty. In case the response comprises an update patch, the patch handler may send the patch to the patch integrator module 304 that is configured to apply the patch to the manifest file that is stored in the memory of the client apparatus. In case the response comprises an information patch, the patch handler may analyse whether any of the new MPD elements made available for the manifest file should be downloaded.

If the client apparatus (or the user of the client apparatus) determines that one or more of the new MPD elements and/or attributes need to be downloaded, the patch handler module 322 may inform the patch initiator to trigger the transmission of a request for an update patch associated with the one or more new MPD elements and/or attributes.

In case the response comprises a full manifest file, the client apparatus may send it to a manifest file replacer module 317. Finally, the response may comprise an empty body. This may be a signal to the client apparatus that there are no updates concerning the manifest part requested by the client or that there are no new elements (representations, adaptation sets) available in the manifest part requested by the client. In both these cases, the client apparatus does not need to take any further action.

Once a response is received and processed, the patch initiator module 324 may reset the timers associated with triggering, the construction and transmission of a request for the type of patch (information or streaming) the response was referring to.

The patch client module in the client apparatus may be configured to communicate with a patch server module 326 in the network. As shown in FIG. 3 such patch server module may comprise a patch request receiver module 332, a patch generator module 330 and a patch sender module 328.

The patch server module, which may be implemented on a network server, may be configured to (i) identify the latest version of the requested MPD parts available at the client; and, (ii) determine the patch that needs to be sent to the client apparatus based on the requested MPD parts and their version; and (iii) send a response to the client.

When a server receives a request message from a client apparatus, e.g. an HTTP GET request message, the patch request receiver will inspect whether the request is a standard HTTP GET request of a new complete MPD or request for updating parts identified in the request. In case the request message is formatted as a request for a patch (e.g. because it not only comprises a manifest file identifier (e.g. an URL or URI identifying the manifest file) but also one or more selected metadata elements of the manifest file) the server determines that the client is requesting a patch and extracts the parameter(s) that are needed for constructing the requested patch.

In case a server that does not support the patch request mechanism receives a patch request, it will respond as network servers (e.g. an HTTP server) normally do when receiving a message that is not recognized. This process usually includes in returning the requested resource without considering the content of the message. Hence, in that case, the response message may include a full MPD.

Once the MF server has identified that a client apparatus has requested a patch and has identified the versions of the MPD parts for which the patch needs to be created, the server needs to determine the patch that needs to be sent to the client. Depending on the request for a patch, the patch generator 330 may generate (at least) one of the following responses:
an update patch, matching the request of the client
an information patch, matching the request of the client
a full manifest file, in case the server decides not to create the requested patch (because it was too time/resource intensive or for any other reason)
an empty body

An empty body may signal the client apparatus that—in case the request was an update patch—there are no updates regarding the manifest part requested by the client. If the request was an information patch, the empty body may signal the client apparatus that there are no new elements (e.g. no new representations, adaptation sets) available in the manifest part requested by the client,

The patch sender 326 may be implemented as an HTTP server function. In case there is no update of the MPD available at the server, the patch sender will send a 200 OK response with empty body. This will inform the client that its version is up-to-date. In case the server has decided to send a patch and has created it for this client apparatus, it will send a HTTP 200 OK response whose body contains a XML document containing the requested patch (either a update patch or an information patch). In case the server has decided not to send the patch but rather the full MPD, it will send a HTTP 200 OK response whose body just contains the MPD.

Details on the format of the different types of responses to the patch requests and response are described hereunder in more detail.

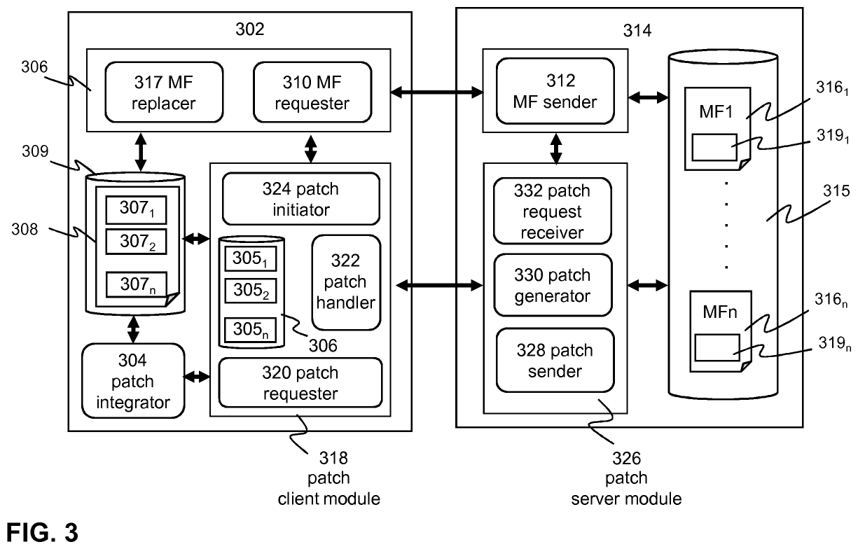

FIG. 4 depicts a functional flow diagram of the process executed by the patch client module according to an embodiment of the invention. As shown in FIG. 4, the process includes the client apparatus, in particular the patch initiator in the client apparatus, controlling one or more timers associated with triggering the construction and transmission of a request for an update patch or an information patch to a server (steps 402 and 404). Additionally, the client apparatus may monitor streaming problems that may require a partial update of the manifest file (step 406).

In an embodiment, one or more trigger events may trigger a client apparatus to send a request for a partial update of the manifest file. These trigger events may include but are not limited to: a timer on the validity of the MPD has elapsed; an information patch containing new metadata elements is received; a streaming problem is detected; the capability information of the client apparatus is reported; media processing device, user input for selecting one or more codecs or qualities is received;

In a further embodiment, metrics of the current streaming session, e.g. Quality of Service metrics (QoS), are received. In an embodiment, QoS metrics may be generated by the client apparatus in accordance with the MPEG DASH SAND standard.

The client apparatus may construct a request for a partial update of the manifest file and send the request to a server (steps 408 and 410). The request may comprise information for identifying the one or more manifest file parts (one or more metadata elements) for which the client apparatus would like to receive new segment identifiers.

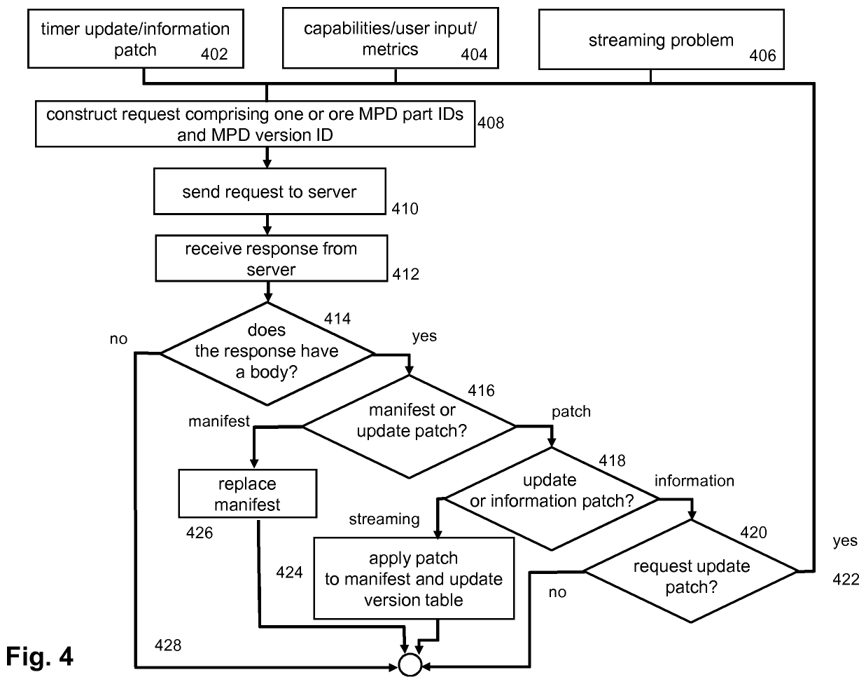

In an embodiment, the patch request may comprise a manifest file version ID or a manifest file part version ID in order to inform the server about the version of the manifest file or manifest file parts that needs to be updated. The server will process the request and send a response back to the client apparatus. The processing of the request will be described hereunder in more detail with reference to FIG. 5.

Once the client apparatus receives a response back from the server, it may check whether the response, e.g. an HTTP response message, comprises a body (step 414). The absence of a body may be interpreted by the client apparatus that no new streaming content and/or new metadata elements, e.g. MPD elements, are available. If the response contains a body, the client apparatus may determine whether the request concerns a request for updating the whole manifest file or a request for selectively updating only a part of manifest file the client apparatus is using (step 416).

In case the request is a manifest file update request, the manifest file replacer in the client apparatus may replace the current manifest file with the received manifest file (step 426).

In case the request is a request for a partial update of the manifest file, the client apparatus may determine whether the patch concerns an update patch or an information patch (step 418). In case of an update patch, the patch integrator in the client apparatus may apply the patch to the manifest file in the memory of the client apparatus so that the updated manifest file allows the client apparatus to access new streaming content, e.g. one or more new segments associated with live streaming video (step 424).

Application of the patch to the manifest file may include identifying the one or more manifest file parts in the manifest file on the basis of the information in the patch and executing the instructions in the patch so that segment identifiers associated with one or more manifest file parts are updated. When the patch has been successfully applied, the patch client module may update the version table so that the table comprises an entry that includes information identifying the manifest file parts that are updated and version identifiers associated with each of the updated manifest file parts. The version identifiers of the updated manifest file parts were sent in the patch response to the client apparatus. The version identifiers may refer to manifest file versions published by the manifest file server, which were used in constructing update patches sent to the client apparatus.

If the patch concerns an information patch, the client apparatus may determine whether it would like to selectively update the manifest file on the basis of one or more new MPD elements that are reported by the information patch to the client. If this is the case, the client apparatus may determine to request an update patch for requesting new segment identifiers associated with the new MPD elements in the information patch (step 420). To that end, the client apparatus may construct an update patch request and send it to the server in a similar way as described above with reference to steps 408 and further.

FIG. 5 depicts a functional flow diagram of the process executed by the patch server module according to an embodiment of the invention. As shown in FIG. 5, when the patch server module receives a request for a update of a manifest file part, it first will check whether the requested manifest file part is up-to-date (steps 502 and 504).

In an embodiment, the patch server module may use a manifest file part version ID in the patch request in order to search the associated manifest file information that is stored in the MF database. If the version ID in the patch request is identical to the version ID of the latest version of the manifest file then the manifest file part is up-to-date. In that case, the patch server module may send a response message, e.g. an HTTP 200 OK message, that has an empty body. The empty body signals the client apparatus that the requested manifest file is up-to-date (step 516).

If the version ID in the patch request is not identical to the version ID of the latest version of the manifest file, the patch server module may determine whether it can construct a patch. In certain situations, e.g. (temporary) lack of resources, it may decide that a patch cannot be constructed. In that case, it may send a response message, e.g. an HTTP 200 OK response, that comprises a complete new manifest file (step 508). Alternatively, if it is possible to construct a patch, it may determine whether the patch request concerns an personalized patch request or an information patch request (step 510).

If the patch server module determines that the patch is an update patch, it will construct an update patch based on the information in the MF database. In an embodiment, patch server module may determine the diff documents between the most recent manifest file and the manifest file that has a version ID that matches the version IDs in the request and select from these diff documents the requested patch.

Thereafter, it may send the patch in a response message to the client apparatus wherein the patch may include a patch version ID for the client apparatus. Alternatively, if the patch server module determines that the patch is an information patch, it will construct an update patch based on the information in the MF database and send the patch in a response message to the client apparatus.

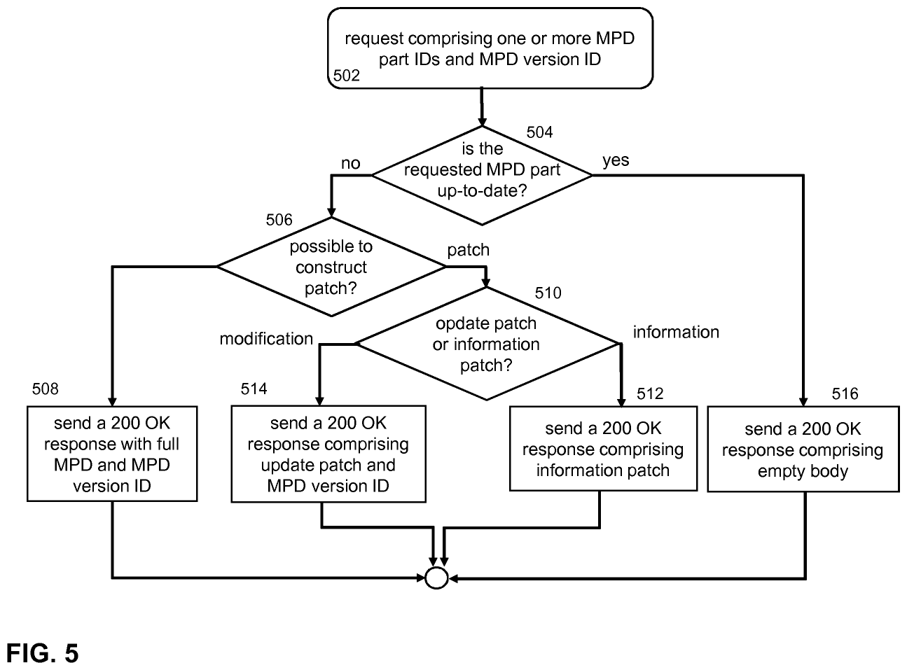

FIG. 6 depicts a flow diagram for a patch request/response interaction between client and a server according to an embodiment of the invention. The client apparatus may be aware of the server supporting personalized patches. Alternatively, the server may inform the client apparatus on its capabilities. In an embodiment, the server may transmit a manifest file to the client apparatus, wherein the manifest file may include server capability information, including its ability to support personalized patches, i.e. update patch, information patch, or both (step 602). Instead of inserting the server capability information in the manifest file, the information may be transmitted in a separate message to the client apparatus. When the client apparatus receives the manifest file, it may check the server capabilities on the basis of the information in the manifest file (step 604).

If the information indicates that the server supports personalized patches, it may send a patch request to the server (step 606). The server may determine the patch (step 608) (e.g. an update patch or an information patch) on the basis of in formation the request (which in some embodiments may comprise a manifest file version ID or one or more manifest file part version IDs) and the stored manifest file information in the MF database. The server may send the patch in a response message to the client apparatus (step 610). In some embodiments, the response may comprise a manifest file version ID. The client apparatus may parse the patch, determine the type of patch and process it accordingly (step 612).

Hereafter processes, functions and data formats are described that enable a client apparatus and server to manage the use of patches as described above with reference to FIG. 1-6. These processes, functions and data formats may include at least methods to keep track of the versions of the different manifest parts present at the client data format for streaming and information patch requests and responses to such requests, and methods for parsing and interpreting patch responses.

As described above, a patch may have the format of a “diff” between the version of the MPD part available at the server and the version of the same MPD part available at the client. Therefore, in order to be able to request a patch, the client apparatus needs to know the version of each part of the manifest file it owns.

In an embodiment, the version management may be based on the basis of an ETag scheme as defined in the HTTP/1.1 protocol RFC7232 which may be incorporated by reference into this description. As described in RFC7232, the ETag scheme in an header field of a HTTP response is meant to be used for differentiating between multiple representations of the same resource. While the ETag scheme is usually used to improve caching efficiency, the same underlying principle (i.e. saving bandwidth) also holds for the patch requests, where the ETag may be used as identifiers of versions of the manifest files that are published by the MF server.

The ETag scheme provides the advantage that it is DASH agnostic and allows information to be inserted in the header of HTTP response messages.

In order to take advantage of the ETag scheme, the server is configured to determine an ETag value that is a strong validator (i.e. that uniquely identifies a specific manifest file version). In this embodiment the server may use a hash, e.g. a MD5 hash, that is based on (part of) the manifest file as value for the ETag. In an embodiment, the MD5 hash function may be used as a strong validator as the value of a MD5 hash changes whenever a single bit of the manifest file changes.

The client apparatus needs to maintain a mapping between manifest parts and their versions. This mapping is needed because, when a client apparatus receives an update patch for updating a specific part of the MPD (e.g. one Adaptation Set), only that part of manifest file that is currently used by the client apparatus is updated, whereas the rest of the manifest file remains identical stays the same.

In an embodiment, the client apparatus may use an “ETag mapping list”, which comprising tuples <Element, ETag>, where “Element” represents an element of the XML tree of the MPD and “ETag” is the ETag corresponding to the manifest version the Element was retrieved from.

The tuple containing the “MPD” element is always present in the ETag mapping list and its ETag is relative to the version of the last complete manifest file retrieved by this client.

When an entry containing <ElementX, ETagX> is present in the ETag mapping list, it means that that element and all its children are present in the version identified by the ETag of value “ETagX”, or in a newer version, should they also appear as separate elements in the ETag mapping list. If an element is not present in any of the tuples in the ETag mapping list, it means that that element is at the same version of its closest parent element present in the ETag mapping list. Hence, the manifest version management at the client apparatus is more complex than a conventional resource version management used in caching schemes.

As an example, a client apparatus may retrieve a dynamic manifest file defining streaming content for different camera views, wherein one camera view (C1) can be viewed with two different bandwidths (sample.mpd). An example of such MPD that is stored in a predetermined data format in the memory of a client apparatus is shown in Table 1A:

TABLE 1A
<?xml version=“1.0” encoding=“UTF-8”?>
<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011 DASH-MPD.xsd”
type=“dynamic”
minimumUpdatePeriod=“PT3S”
availabilityStartTime=“2015-07-25T12:30:00”
minBufferTime=“PT6.00S”
publishTime=“2015-07-25T12:30:09Z”
profiles=“urn:mpeg:dash:profile:isoff-main:2011”>
<BaseURL>http://www.example.com/</BaseURL>
<!-- In this Period there are 3 views, coming from three lined up cameras: C1-C2-C3. -->
<Period start=“PT0.00S” duration=“PT2000.00S” id=“1”>

<SegmentList>

<Initialization sourceURL=“seg-m-init.mp4”/>

</SegmentList>
<AdaptationSet mimeType=“video/mp4” id=“1”>

<Representation id=“C1_1” bandwidth=“128000” codecs=“avc1.640828”>

<SegmentList duration=“3”>

<SegmentURL media=“seg-m1-C1_1view-1.mp4”/>
<SegmentURL media=“seg-m1-C1_1view-2.mp4”/>
<SegmentURL media=“seg-m1-C1_1view-3.mp4”/>

</SegmentList>

</Representation>
<Representation id=“C1_2” bandwidth=“512000” codecs=“mvc1.760028”>

<SegmentList duration=“3”>

<SegmentURL media=“seg-m1-C1_2view-1.mp4”/>
<SegmentURL media=“seg-m1-C1_2view-2.mp4”/>
<SegmentURL media=“seg-m1-C1_2view-3.mp4”/>

</SegmentList>

</Representation>

</AdaptationSet>
<AdaptationSet mimeType=“video/mp4” codecs=“mvc1.760028” id=“2”>

<Representation id=“C2” bandwidth=“192000”>

<SegmentList duration=“3”>

<SegmentURL media=“seg-m1-C2view-1.mp4”/>
<SegmentURL media=“seg-m1-C2view-2.mp4”/>
<SegmentURL media=“seg-m1-C2view-3.mp4”/>

</SegmentList>

</Representation>

</AdaptationSet>
<AdaptationSet mimeType=“video/mp4” codecs=“mvc1.760028” id=“3”>

<Representation id=“C3” bandwidth=“192000”>

<SegmentList duration=“3”>

<SegmentURL media=“seg-m1-C3view-1.mp4”/>
<SegmentURL media=“seg-m1-C3view-2.mp4”/>
<SegmentURL media=“seg-m1-C3view-3.mp4”/>

</SegmentList>

</Representation>

</AdaptationSet>

</Period>

</MPD>

When it stores the MPD in the memory, the client apparatus may determine a first MPD version identifier for identifying the version of the MPD the client apparatus is using. In an embodiment, the first MPD version identifier may be based on the hash of (part of) the MPD. For example, in an embodiment, the client apparatus may generate a hash value, e.g. an ETag, of the MPD element of the MPD and store this value in a table. Alternatively, instead of the client apparatus determining the MPD version identifier, the server may determine the MPD version identifier and send the MPD version identifier, e.g. in the form of an ETag, together with the MPD in a response message, e.g. an HTTP response message, to the client apparatus.

In any case, the MF server may use MPD version identifiers in order to keep track of all MPD versions of a video title that become available so that when the server receives a patch request comprising a reference to a version number, the server is able to identify the version the client apparatus is currently using and is able to determine whether this version is the latest version or an earlier version.

The client apparatus may create a table including the MPD element and the associated MPD version identifier (e.g. a hash value such as an ETag). In an embodiment, when using the ETag scheme, the client apparatus may create an ETag mapping list and insert the MPD element and the associated ETag as an entry in the list. In an embodiment, the MPD element may be used to identify the manifest file the client apparatus initially retrieved when starting a streaming session. An example of such entry of the body of an MPD is shown in table 2:

TABLE 2

| Element | ETag |
|---|---|
| <MPD | F561F4415CFE67AABDC5C597EA79419E |

xmlns:xsi=“http://www.w3.org/2001/XMLSchema-instance“
xmlns=“urn:mpeg:dash:schema:mpd:2011”
xsi:schemaLocation=“urn:mpeg:dash:schema:mpd:2011
DASH-MPD.xsd”
type=“dynamic”
minimumUpdatePeriod=“PT3S”
availabilityStartTime=“2015-07-25T12:30:00”
minBufferTime=“PT6.00S”
publishTime=“2015-07-25T12:30:09Z”
profiles=“urn:mpeg:dash:profile:isoff-main:2011”>

Meanwhile a new version of the MPD (having a new publishTime attribute) may published at the MF server. The server may calculate an MPD version identifier, e.g. an ETag value 0D7042536D65AA3C8FF40A788A060D18, associated with the newly published version of the MPD.

TABLE 1B
<?xml version=“1.0” encoding=“UTF-8”?>
<MPD

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011 DASH-MPD.xsd”
type=“dynamic”
minimumUpdatePeriod=“PT3S”
availabilityStartTime=“2015-07-25T12:30:00”
minBufferTime=“PT6.00S”
publishTime=“2015-07-25T12:38:12Z”
profiles=“urn:mpeg:dash:profile:isoff-main:2011”>
<BaseURL>http://www.example.com/</BaseURL>
<!-- In this Period there are 3 views, coming from three lined up cameras: C1-C2-C3. -->
<Period start=“PT0.00S” duration=“PT2000.00S” id=“1”>

<SegmentList>

<Initialization sourceURL=“seg-m-init.mp4”/>

</SegmentList>
<AdaptationSet mimeType=“video/mp4” id=“1”>

<Representation id=“C1_1” bandwidth=“128000” codecs=“avc1.640828”>

<SegmentList duration=“3”>

<SegmentURL media=“seg-m1-C1_1view-1.mp4”/>
<SegmentURL media=“seg-m1-C1_1view-2.mp4”/>
<SegmentURL media=“seg-m1-C1_1view-3.mp4”/>
<SegmentURL media=“seg-m1-C1_1view-4.mp4”/>
<SegmentURL media=“seg-m1-C1_1view-5.mp4”/>

</SegmentList>

</Representation>
<Representation id=“C1_2” bandwidth=“512000” codecs=“mvc1.760028”>

<SegmentList duration=“3”>

<SegmentURL media=“seg-m1-C1_2view-1.mp4”/>
<SegmentURL media=“seg-m1-C1_2view-2.mp4”/>
<SegmentURL media=“seg-m1-C1_2view-3.mp4”/>
<SegmentURL media=“seg-m1-C1_2view-4.mp4”/>
<SegmentURL media=“seg-m1-C1_2view-5.mp4”/>

</SegmentList>

</Representation

</AdaptationSet>
<AdaptationSet mimeType=“video/mp4” codecs=“mvc1.760028” id=“2”>

<Representation id=“C2” bandwidth=“192000”>

<SegmentList duration=“3”>

<SegmentURL media=“seg-m1-C2view-1.mp4”/>
<SegmentURL media=“seg-m1-C2view-2.mp4”/>
<SegmentURL media=“seg-m1-C2view-3.mp4”/>
<SegmentURL media=“seg-m1-C2view-4.mp4”/>
<SegmentURL media=“seg-m1-C2view-5.mp4”/>

</SegmentList>

</Representation>

</AdaptationSet>
<AdaptationSet mimeType=“video/mp4” codecs=“mvc1.760028” id=“3”>

<Representation id=“C3” bandwidth=“192000”>

<SegmentList duration=“3”>

<SegmentURL media=“seg-m1-C3view-1.mp4”/>
<SegmentURL media=“seg-m1-C3view-2.mp4”/>
<SegmentURL media=“seg-m1-C3view-3.mp4”/>
<SegmentURL media=“seg-m1-C3view-4.mp4”/>
<SegmentURL media=“seg-m1-C3view-5.mp4”/>

</SegmentList>

</Representation>

</AdaptationSet>

</Period>

</MPD>

A user of the client apparatus receiving a manifest file as described in Table 1A may indicate that he or she is only interested in the low-resolution version of the video at an angle taken from the first camera (i.e. the Representation with id=C1_1) and with the lowest resolution as the video is rendered on a smartphone. Hence, after a predetermined period (typically a few seconds) from downloading the manifest file (which may correspond to the minimumUpdatePeriod of the MPD), the client apparatus may request an update patch of Representation C1_1 only, wherein the request comprises the MPD version identifier of the MPD the client apparatus is currently using. When the server receives the patch request, it will determine on the basis of the MPD version identifier in the patch request that a new version of the MPD is available. Then, based on the information in the patch request, the server may construct a patch comprising the new segment identifiers, i.e. the new URLs, of Representation C1_1 and send the patch in a response message to the client apparatus. In addition to the patch, the server may insert the MPD version identifier of the MPD that patch was based on into the response message (e.g. in the HTTP header or in the body of the message).

After receiving the update patch in a response message, the client apparatus may apply the update patch to the manifest file so that the part of the manifest file that is identified in the patch is updated. After application of the patch to the MPD, the MPD will comprise a main body, that is based on the MPD identified by a first MPD version identifier (the first ETag value) and an updated part that is based on the most current version of the MPD published by the MF server.

An example of the MPD after the first patch update is shown in table 3:

TABLE 3
<?xml version=“1.0” encoding=“UTF-8”?>
<MPD

xmlns:xsi=“http://www.w3.org/2001/XMLSchema-instance“
xmlns=“urn:mpeg:dash:schema:mpd:2011”
xsi:schemaLocation=“urn:mpeg:dash:schema:mpd:2011 DASH-MPD.xsd”
type=“dynamic”
minimumUpdatePeriod=“PT3S”
availabilityStartTime=“2015-07-25T12:30:00”
minBufferTime=“PT6.00S”
publishTime“2015-07-25T12:38:12Z” profiles=“urn:mpeg:dash:profile:isoff-main:2011”>
<BaseURL>http://www.example.com/</BaseURL>
<!-- In this Period there are 3 views, coming from three lined up cameras: C1-C2-C3. -->
<Period start=“PT0.00S” duration=“PT2000.00S” id=“1”>

<SegmentList>

<Initialization sourceURL=“seg-m-init.mp4”/>

</SegmentList>
<AdaptationSet mimeType=“video/mp4” id=“1”>

<Representation id=“C1_1” bandwidth=“128000” codecs=“avc1.640828”>

<SegmentList duration=“3”>

<SegmentURL media=“seg-m1-C1_1view-1.mp4”/>
<SegmentURL media=“seg-m1-C1_1view-2.mp4”/>
<SegmentURL media=“seg-m1-C1_1view-3.mp4”/>
<SegmentURL media=“seg-m1-C1_1view-4.mp4”/>
<SegmentURL media=“seg-m1-C1_1view-5.mp4”/>

</SegmentList>

</Representation>
<Representation id=“C1_2” bandwidth=“512000” codecs=“mvc1.760028”>

<SegmentList duration=“3”>

<SegmentURL media=“seg-m1-C1_2view-1.mp4”/>
<SegmentURL media=“seg-m1-C1_2view-2.mp4”/>
<SegmentURL media=“seg-m1-C1_2view-3.mp4”/>

</SegmentList>

</Representation>

</AdaptationSet>
<AdaptationSet mimeType=“video/mp4” codecs=“mvc1.760028” id=“2”>

<Representation id=“C2” bandwidth=“192000”>

<SegmentList duration=“3”>

<SegmentURL media=“seg-m1-C2view-1.mp4”/>
<SegmentURL media=“seg-m1-C2view-2.mp4”/>
<SegmentURL media=“seg-m1-C2view-3.mp4”/>

</SegmentList>

</Representation>

</AdaptationSet>
<AdaptationSet mimeType=“video/mp4” codecs=“mvc1.760028” id=“3”>

<Representation id=“C3” bandwidth=“192000”>

<SegmentList duration=“3”>

<SegmentURL media=“seg-m1-C3view-1.mp4”/>
<SegmentURL media=“seg-m1-C3view-2.mp4”/>
<SegmentURL media=“seg-m1-C3view-3.mp4”/>

</SegmentList>

</Representation

</AdaptationSet>

</Period>

</MPD>

As shown in table 3, the MPD version (PubfishTime=2015-07-25T12:38:12Z) has not changed, while the Representation C1_1 is updated with two new segments. After having applied the patch to the MPD, the client apparatus will update the ETag mapping list on the basis of the information in the patch and on the basis of ETag value of the updated manifest file (i.e. the hash value of the updated manifest file that is used by the client apparatus). In that case, the ETag mapping list may comprise two entries as shown in Table 4:

TABLE 4

| Element | ETag |
|---|---|
| <MPD | F561F4415CFE67AABDC5C597EA79419E |

xmlns:xsi=“http://www.w3.org/2001/XMLSchema-instance”
xmlns=“urn:mpeg:dash:schema:mpd:2011”
xsi:schemaLocation=“urn:mpeg:dash:schema:mpd:2011
DASH-MPD.xsd”
type=“dynamic”
minimumUpdatePeriod=“PT3S”
availabilityStartTime=“2015-07-25T12:30:00”
minBufferTime=“PT6.00S”
publishTime=“2015-07-25T12:38:12Z”
profiles=“urn:mpeg:dash:profile:isoff-main:2011”>

| | |
|---|---|
| <Representation id=“C1_1” bandwidth=“128000” codecs=“avc1.640828”> | 0D7042536D65AA3C8FF40A788A060D18 |

The ETag mapping list now indicates that the element <Representation id=“C1_1” bandwidth=“128000” codecs=“avc1.640828”> and all its children elements are derived from an version of the MPD version identified by the second (newer) MPD version identifier, (i.e. the second ETag 0D7042536D65AA3C8FF40A788A060D18), while the body of the MPD is identified by the (older) first

MPD version identifier (i.e. the first ETag F561F4415CFE67AABDC5C597EA79419E).

Hence, the client apparatus according to the invention is able to identify parts of an MPD (manifest file parts) it would like to update, request a patch for updating a manifest file part and updating the manifest file part on the basis of the patch received from a server. In order to keep track of the version of the different manifest file parts, the client apparatus may comprise a version management processor. The version management processor may produce a mapping list identifying at least the MPD version identifier of last full manifest file that was received by the client apparatus (e.g. the MPD element in table 4 and the MPD version identifiers associated with the manifest file parts, (e.g. the Representation element in table 4 that are updated on the basis of a patch.

In an embodiment, the client apparatus may be configured to request an update patch. For this purpose, the client apparatus may select an element E of the MPD tree for which it would like to request an update and provide or determine its corresponding ETag. In an embodiment, an element of the MPD tree may be selected using a suitable function that allows selection of one or more nodes from a data structure that defines the MPD, e.g. an XML document or the like. In an embodiment, an element of the MPD document may be selected on the basis of the XPath language, a standard query language defined by the W3C for selecting elements from an XML document (such as the MPD). If not all children elements in the element E subtree have the same version, the request needs to be split into a number of separate XPath queries, covering the elements of different versions within the element E subtree.

In an embodiment, a client apparatus may request the an update patch using a HTTP GET request. To this end, the client apparatus may construct an URI query string carrying the XPath query and corresponding ETag. In an embodiment, the syntax for the request may be compliant with RFC3986 which may be incorporated by reference in this application. The format of the request may be as follows:

GET URI HTTP/1.1
with:
URI = Scheme “:” hier-part [“?” path & id]
hier-part = “//” authority path-abempty

/ path-absolute
/ path-rootless
/ path-empty

path = “XPath=” [XPath]
id = “ETag=” ETag]

In an embodiment, the format may comprise a number of sequences of “XPath=” [XPath] and “ETag=” [ETag], in order to select a number of MPD elements characterised by different ETags (i.e. version numbers). In order to receive a response, the client apparatus needs to support a HTTP 200 OK response in a format that is provided by the server. Examples of such response messages are described hereunder.

In a first example, the MPD sample.mpd as described in Table 1A may be used. In order request an update patch of Representation C1_1, the client apparatus may construct and transmit the following HTTP request message:

### GET

http://www.example.com/sample.mpd?ETag=F561F4415CFE67AABDC5C597EA79419E&XPath=/MP D/Period[@id=“1”]/AdaptationSet[@id=“1”]/Representation[@id=“C1_1”]

Based on the syntax described above, the client apparatus may use the HTTP GET message for requesting a patch, signalling to the server that:
the client apparatus is requesting a patch (by the presence of the URI query string)
of type “update patch” (by the presence of “ETag” and “XPath” parameters in the URI query string)
for the element Representation[@id=“C1_1”]
of a DASH manifest file sample.mpd located at http://www.example.com
whose last version available at the client apparatus has ETag=F561F4415CFE67AABDC5C597EA79419E

The example above represents a vertical patch, since it references a unique element in the MPD tree.

In an embodiment, the request may represent a request for a horizontal update patch. Such horizontal patch may comprise multiple metadata elements having one or more common characteristics (i.e. all Representations in Period 1 with bandwidth=“192000”, independently from which Adaptation Set they are located into). With reference to the MPD sample.mpd in Table 1A, the request may look as follows:

### GET

http://www.example.com/sample.mpd?ETag=F561F4415CFE67AABDC5C597EA79419E&XPath=/MP D/Period[@id=“1”]/*/ Representation[@bandwidth=“192000”]

In an embodiment, the request may define a request comprising multiple, in this example two, tuples of “XPath”, “ETag” query parameters. For this example, a client apparatus may have the MPD in Table 3, and the ETag mapping list in Table 4. The client apparatus may need an update relative to the whole Adaptation set with ID=1, because it would like to stream the video at other resolutions. It is noted that representation C1_1 is at a newer version than representation C1_2. The client therefore may request a patch for representation C1_1 and another for representation C1_2. An example of such request may have the following format:

### GET

http://www.example.com/sample.mpd?ETag=0D7042536D65AA3C8FF40A788A060D18&XPath=/MP D/Period[@id=“1”]/AdaptationSet[@id=“1”]/Representation[@id=“C1_1”]&ETag=F561F4415CFE67AABDC5C597EA79419E &XPath=/MPD/Period[@start=“PT0.00S”]/AdaptationSet[@id=“1”]/Representation[@id=“C1_2”]

If the server receives a request for an update patch, e.g. an HTTP request as described above, it may parse the HTTP message, determine that the message represents an update patch request and identify the version(s) of the MPD part(s) requested in the patch. Thereafter, the server needs to construct for each of the MPD parts a difference (“diff”) document between the latest version stored in the MF database and the version indicated by the client.

In an embodiment, the server may be configured to maintain the latest version of the MPD (say: version n). Additionally, the server may be configured to maintain the “diff” documents between k previous versions (i.e. the “diff” between version n and n−1, diff_{n,n-1}; the “diff” between version n−1 and n−2, diff_{n-1, n-2}; and so on until diff_{n-k+1, n-k).}

Because the server would need the full MPD to calculate its MD5 hash (to create the corresponding ETag), the server is not able to create the ETag(s) relative to each MPD in order to compare them with the ETag(s) received in the request. Therefore, the server also maintains a list of MDP ETags along with the diff documents in order to be able to identify the manifest version(s) indicated in the request. The ETag of a new MPD version is calculated at the moment in which that MPD version is created.

Other embodiments regarding how the ETags are maintained/calculated at the server are described hereunder.

The “diff” documents may be used to determine “patches” that a server would embed in a segment block according to the standard patch mechanism of MPEG DASH. This allows the server to support with minimum effort both the standard patch mechanism of MPEG DASH as well as the patch request schemes described in this disclosure.

In an embodiment, the contents of a patch may be built according to the patch scheme as described in “Patch Operations Framework Utilizing XPath Selectors” [RFC5261} which may be incorporated by reference into this application.

When a client apparatus requests a patch for an MPD part with respect to version i of the MPD (with i<n, where n is the latest MPD version published at the server), the server will first retrieve the “diff” documents from diff_{i,i+1} until diff_{n-1,n}; extract from each of these “diff” documents the change on the part requested by the client apparatus and concatenate them in order to obtain a so-called “composite patch”.

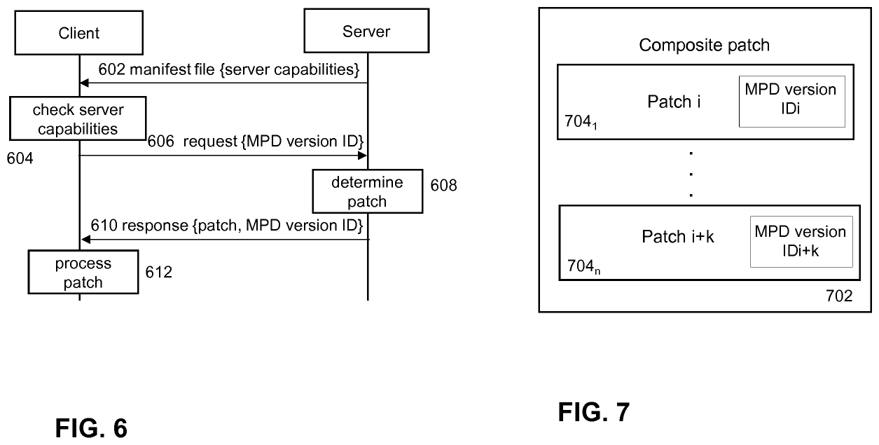

FIG. 7 depicts a composite patch comprising a composite file container 702 comprising one or more patches 704₁₋ₖ. In case n=i+1, only one diff document is needed. Such single diff document may be referred to as an “atomic patch”. In a further embodiment, a composite patch may be the result of a request containing a sequence of more ETag-XPath combinations. Other embodiments on how a patch can be calculated and constructed are described hereunder.

An important rule regarding composite patches is that their composing patches are temporally ordered: from the oldest patch to the newest.

Hence, the body of the HTTP 200 OK server response representing an atomic patch will have a document containing one <diff> element, while the body of a response representing a composite patch may comprise a data structure comprising a concatenation of <diff> elements. The header of the HTTP 200 OK response may contain the ETag relative to the latest manifest version. In a following embodiment, the request reported in Example 1 may be considered (which is based on the MPD sample.mpd in Table 1A):

### GET

http://www.example.com/sample.mpd?ETag=F561F4415CFE67AABDC5C597EA79419E&XPath=/MP D/Period[@id=“1”]/AdaptationSet[@id=“1”]/Representation[@id=“C1_1”]

In this embodiment, one new version of the MPD may have been published since the one downloaded by the client apparatus, and this new version has been assigned the following ETag: 0D7042536D65AA3C8FF40A788A060D18. The server may determine the “diff” document between these new versions. Table 5 provides an example of such diff document:

TABLE 5
<?xml version=″1.0″ encoding=″UTF-8″?>
<diff>
<add sel=″MPD[@publishTime=″2015-07-
25T12:38:12Z″]/Period[@id=″1″]/AdaptationSet[@id=″1″]/Representation[@id=″C1_1″]/
SegmentList″>
<SegmentURL media=″seg-m1-C1_1view-4.mp4″/><SegmentURL media=″seg-m1-C1_1view-
5.mp4″/></add>
<add sel=″MPD[@publishTime=″2015-07-
25T12:38:12Z″]/Period[@id=″1″]/AdaptationSet[@id=″1″]/Representation[@id=″C1_2″]/
SegmentList″>
<SegmentURL media=″seg-m1-C1_2view-4.mp4″/><SegmentURL media=″seg-m1-C1_2view-
5.mp4″/></add>
<add sel=″MPD[@publishTime=″2015-07-
25T12:38:12Z″]/Period[@id=″1″]/AdaptationSet[@id=″2″]/Representation[@id=″C2″]/
SegmentList″><S
egmentURL media=″seg-m1-C2view-4.mp4″/><SegmentURL media=″seg-m1-C2view-
5.mp4″/></add>
<add sel=″MPD[@publishTime=″2015-07-
25T12:38:12Z″]/Period[@id=″1″]/AdaptationSet[@id=″3″]/Representation[@id=″C3″]/
SegmentList″><S
egmentURL media=″seg-m1-C3view-4.mp4″/><SegmentURL media=″seg-m1-C3view-
5.mp4″/></add>
</diff>

As shown in Table 5, the diff document may comprise the update patches that are available for the client. The server may extract from this diff document a diff element that matches the part requested by the client (e.g. in this example the part referring to representation C1_1) and construct the following atomic update patch as shown in Table 6:

TABLE 6
<?xml version=″1.0″ encoding=″UTF-8″?>
<diff>
<add sel=″MPD[@publishTime=″2015-07-
25T12:38:12Z″]/Period[@id=″1″]/AdaptationSet[@id=″1″]/Representation[@id=″C1_1″]/
SegmentList″>
<SegmentURL media=″seg-m1-C1_1view-4.mp4″/><SegmentURL media=″seg-m1-C1_1view-
5.mp4″/></add>
</diff>

The <diff> element shown in Table 6 is the information that the server will dispatch in the response to the client's request.

In a further embodiment, the request reported in Example 1 may be considered (which is based on the MPD sample.mpd in Table 1A). In this embodiment, however three new versions of the MPD have been produced since the client's request, and the server has the corresponding three update patches) available. From each “diff” document, the server may extract the <diff> element associated with the part referring to C1_1. These <diff> elements are used in the construction of a composite patch. An example of such composite update patch is illustrated in Table 7:

```
TABLE 7
<?xml version=″1.0″ encoding=″UTF-8″?>
<diff>
  <add sel=″MPD[@publishTime=″2015-07-
25T12:38:12Z″]/Period[@id=″1″]/AdaptationSet[@id=″1″]/Representation[@id=″C1_1″]/
SegmentList″>
<SegmentURL media=″seg-m1-C1_1view-4.mp4″/></add>
</diff>
<diff>
  <add sel=″MPD[@publishTime=″2015-07-
25T12:40:12Z″]/Period[@id=″1″]/AdaptationSet[@id=″1″]/Representation[@id=″C1_1″]/
SegmentList″>
<SegmentURL media=″seg-m1-C1_1view-5.mp4″/></add>
</diff>
<diff>
  <add sel=″MPD[@publishTime=″2015-07-
25T12:43:15Z″]/Period[@id=″1″]/AdaptationSet[@id=″1″]/Representation[@id=″C1_1″]/
SegmentList″>
<SegmentURL media=″seg-m1-C1_1view-6.mp4″/></add>
</diff>
```

As shown in this table, the (three) individual patches (the <diff> elements) are arranged in temporal order. In an embodiment, the temporal order may be based on the value of the publishTime parameter they refer to.

In an embodiment, the request reported in Example 1 may be considered (which is based on the MPD sample.mpd in Table 1A). In this embodiment however four new versions of the MPD may have been produced since the client's request, and the server does not have all corresponding MPD patches available. Because not all MPD patches are available, the server is not able to construct the requested patch therefore the server choses to send a complete MPD instead. An alternative embodiment dealing with this situation is described hereunder in more detail.

In a further embodiment, the request may be similar to the request for a horizontal patch as described with reference to example two above (using the MPD sample.mpd in Table 1A). This horizontal patch may comprise multiple elements with one or more common characteristics (e.g. all Representations in Period 1 having a certain bandwidth=“192000”).

### GET

http://www.example.com/sample.mpd?ETag=F561F4415CFE67AABDC5C597EA79419E&XPath=/MP D/Period[@id=“1”]/*/Representation[@bandwidth=“192000”]

In case only one new version of the MPD has been published since the one downloaded by the client, the server may construct an atomic update patch for this client. An example of such atomic patch is provided in table 7:

```
TABLE 7
<?xml version=″1.0″ encoding=″UTF-8″?>
<diff>
  <add sel=″MPD[@publishTime=″2015-07-
25T12:38:12Z″]/Period[@id=″1″]/AdaptationSet[@id=″2″]/Representation[@id=″C2″]/
SegmentList″><S
egmentURL media=″seg-m1-C2view-4.mp4″/><SegmentURL media=″seg-m1-C2view-
5.mp4″/></add>
  <add sel=″MPD[@publishTime=″2015-07-
25T12:38:12Z″]/Period[@id=″1″]/AdaptationSet[@id=″3″]/Representation[@id=″C3″]/
SegmentList″><S
egmentURL media=″seg-m1-C3view-4.mp4″/><SegmentURL media=″seg-m1-C3view-
5.mp4″/></add>
</diff>
```

Hence, this atomic update patch is configured to add (two) new segment URLs to the MPD that are associated with a Representation of a predetermined bandwidth (in this example bandwidth=“192000”).

In an embodiment, the patch request of the third example (relative to a client apparatus having the MPD in Table 3, and the ETag mapping list in Table 4) may be considered. This patch request comprises a sequence of two “ETag”, “XPath” combinations:

GET http://www.example.com/sample.mpd?ETag=0D7042536D65AA3C8FF40A788A060D18&XPath=/MPD/Period[@id=“1”]/AdaptationSet[@id=“1”]/Representation[@id=“C1_1”]&ETag=F561F4415CFE67AABDC5C597EA79419E &XPath=/MPD/Period[@start=“PT0.00S”]/AdaptationSet[@id=“1”]/Representation[@id=“C1_2”]

In this particular case only one new MPD has been created after the one with ETag 0D7042536D65AA3C8FF40A788A060D18. This means that the part referenced by the first XPath in 3 0 the request is one version behind while the part referenced by the second XPath in the request is two versions behind. Consequently, the server may extract the patch referenced by the first XPath from the most recent “diff” document and the one referenced by the second XPath from the last two MPD “diff” documents, and will return to the client a composite patch as shown in table 8:

```
TABLE 8
<?xml version=″1.0″ encoding=″UTF-8″?>
<diff>
  <add sel=″MPD[@publishTime=″2015-07-
25T12:38:12Z″]/Period[@id=″1″]/AdaptationSet[@id=″1″]/Representation[@id=″C1_2″]/
SegmentList″>
<SegmentURL media=″seg-m1-C1_2view-4.mp4″/><SegmentURL media=″seg-m1-C1_2view-
5.mp4″/></add>
</diff>
<diff>
  <add sel=″MPD[@publishTime=″2015-07-
25T12:40:12Z″]/Period[@id=″1″]/AdaptationSet[@id=″1″]/Representation[@id=″C1_1″]/
SegmentList″>
<SegmentURL media=″seg-m1-C1_1view-6.mp4″/><SegmentURL media=″seg-m1-C1_1view-
7.mp4″/></add>
  <add sel=″MPD[@publishTime=″2015-07-
25T12:40:12Z″]/Period[@id=″1″]/AdaptationSet[@id=″1″]/Representation[@id=″C1_2″]/
SegmentList″>
<SegmentURL media=″seg-m1-C1_2view-6.mp4″/><SegmentURL media=″seg-m1-C1_2view-
7.mp4″/></add>
</diff>
```

Also in this case the individual patches are ordered in time on the basis of the value of the publishTime parameter.

Instead of an update patch, a client apparatus may send an information patch to the server in order to request whether new/different content formats have been made available for a certain content the client apparatus is interested in. On the basis of an information patch, a client apparatus may request:
whether new Periods, new Adaptation Sets associated with an existing Period or new Representations associated with an existing Adaptation Set are available and their corresponding characteristics (bandwidth, codec, screen size, etc. . . . )
whether attributes of existing Periods, Adaptation Sets or Representations have changed over the last period

The information patch request has an almost identical structure as the personalized patch request. There are only two differences:
It is possible to reference an element's attribute (i.e. to ask whether it has changed over time)
The URI query string contains the additional parameter Info=true
   Hence, the HTTP information request message may have the following format:

```
GET URI HTTP/1.1
with:
URI = Scheme ″:″ hier-part [″?″ info & path & id]
hier-part = ″//″ authority path-abempty
  / path-absolute
  / path-rootless
  / path-empty
info = ″Info=true″
path = ″XPath=″ [XPath]
id = ″ETag=″ [ETag]
```

As in the case of update patches, a number of sequences of “XPath=”[XPath] and “ETag=” [ETag] may be used in order to select different elements characterised by different ETags.

Hereunder a (non-limiting) number of embodiments of (vertical and horizontal) information patches are described. In an embodiment, a vertical information patch on an element may be used by the client apparatus. For example, the client may want to know if there are updates (e.g. other resolutions, bandwidth or codecs) regarding a specific Adaptation Set representing a video type. In that case, the client apparatus may determine the following information patch:

### GET

http://www.example.com/sample.mpd?Info=true&ETag=F561F4415CFE67AABDC5C597EA79419E& XPath=/MPD/Period[@id=“1”]/AdaptationSet[@id=“1”]

This request will inform the server that the client apparatus is interested in any updates regarding the change/addition of content formats in the adaptation set 1 of period 1.

In an embodiment, the client apparatus may use an information patch in order to retrieve information on an attribute. For example, a client apparatus may want to know if there are updates in the resolutions of the representations in adaptation set 1 having a specific codec (because the client can only decode that codec for instance). The client apparatus may request this information on the basis of the following information patch:

### GET

http://www.example.com/sample.mpd?Info=true&ETag=F561F4415CFE67AABDC5C597EA79419E& XPath=/MPD/Period[@id=“1”]/AdaptationSet[@id=“1”]/Representation[@codecs=“mvc1.760028”]/@h eight

This request informs the server that the client would like to know whether there is an update of the “height” attribute of Representations with codec “mvc.760028” within Adaptation Set 1 of Period 1.

In an embodiment, the client apparatus may use a horizontal information patch in order to retrieve information on element level. For example, a client apparatus may want to know if there are updates (e.g. other resolutions, bandwidth) for all video representations having a specific codec (for example because the client can only decode that codec). The client apparatus may request this information on the basis of the following information patch:

### GET

http://www.example.com/sample.mpd?Info=true&ETag=F561F4415CFE67AABDC5C597EA79419E& XPath=/MPD/*/AdaptationSet[@mimeType=“video/mp4”]/Representation[@codecs=“mvc1.760028”]

This request will inform the server that the client wishes to know whether there is an update of any attribute of Representations with codec “mvc.760028”.

In an embodiment, the client apparatus may use a horizontal information patch in order to retrieve information on an attribute. For example, a client apparatus may want to know if there are updates in the resolutions of all video representations having a specific codec (because the client can only decode that codec for instance). In that case, a client apparatus may request an information patch as follows:

### GET

http://www.example.com/sample.mpd? Info=true&ETag=F561F4415CFE67AABDC5C597EA79419E& XPath=/MPD/*/AdaptationSet[@mimeType=“video/mp4”]/Representation[@codecs=“mvc1.760028”]/@height

This request will inform the server that the client wishes to know whether there is an update of the “height” attribute of any representations with codec “mvc.760028”.

In an embodiment, the client apparatus may use an information patch in order to retrieve information on a MPD part with non-uniform versions. For example, a client may want to know if there are updates (e.g. other resolutions, bandwidth or codecs) regarding two Adaptation Sets, Adaptation Set #1 and Adaptation Set #2. Adaptation Set #1 may be at a version newer than the Adaptation Set #2.

The client apparatus may request an information patch using a sequence of multiple (in this example two) ETag, XPath combinations as follows:

### GET

http://www.example.com/sample.mpd?Info=true&ETag=0D7042536D65AA3C8FF40A788A060D18&X Path=/MPD/Period[@id=“1”]/AdaptationSet[@id=“1”]&ETag=F561F4415CFE67AABDC5C597EA79419E&XPath=/MPD/Period[@start=“PT0.00S”]/AdaptationSet[ @id=“2”]

When the server receives a request, it may parse it and determine that the request is an information patch request. Additionally, it may determine the version(s) of the MPD part(s) whose update is requested in the patch. In an embodiment, the server may keep the current version n of the MPD along with the k previous versions, and calculate the patch at request time. Once the content of a patch has been calculated, the patch can be constructed.

Two patch formats may be possible: an atomic patch and composite patch. A composite patch may be returned in the response to a request containing a sequence of more ETag, XPath combinations. A composite patch may also result from the way in which the server stores the various MPDs versions.

In order to distinguish information patches from update patches, an information patch may be identified by a <infodiff> element (to distinguish them from the update patches, which use the <diff> element). Hence, a composite information patch may contain a concatenation of <infodiff> elements.

The content of an information patch is formatted as follows:
For each requested element whose attributes have changed, these attributes are reported with their new values
For each requested element's attributes that has changed, its value is reported
The target element or attribute is addressed using the XPath language (in a similar way as in the request)

In an embodiment, the syntax of the information patch content may be based on the standard “Patch Operations Framework Utilizing XPath Selectors” [RFC5261] (which is also used for the update patch). However, instead of the tags <add>, <replace>, <remove> that are used in the update patch, an information patch will use <added>, <replaced>, <removed>, respectively. If there are no updates, the server's response may have an empty body.

Examples of responses comprising information patches are described hereunder. For example, when the request is an information patch on an element as described above with reference to example 1:

### GET

http://www.example.com/sample.mpd?Info=true&ETag=F561F4415CFE67AABDC5C597EA79419E& XPath=/MPD/Period[@id=“1”]/AdaptationSet[@id=“1”]

Then, if new Representations are available, the server will may send a response comprising an update patch for informing the client apparatus that new Representations have been added. Table 9 provides an example of such update patch:

TABLE 9
<?xml version=″1.0″ encoding=″UTF-8″?>
<infodiff>
<added sel=MPD[@publishTime=″2015-07-25T12:38:12Z″]/
Period[@id=″1″]/AdaptationSet[@id=″1″]> <Representation id=″C1_3″
bandwidth=″192000″
codecs=″avc1.640828″>
<Representation id=″C1_4″ bandwidth=″512000″ codecs=″mvc1.760028″>
</added>
</infodiff>

The request may be an information patch on an attribute of <MPD>, e.g. a request on an update of the publishTime of the MPD. In case, the publishTime has changed, the server may send the following patch:

TABLE 10
<?xml version=″1.0″ encoding=″UTF-8″?>
<infodiff>
<replaced sel=MPD[@publishTime=″2015-07-25T12:38:12Z″]/@publishTime>″2015-07-
25T12:30:15Z″
</replaced>
</infodiff>

Hence, this information patch informs the client apparatus that an attribute, in this case the publishTime, has changed.

When the request is an information patch on multiple elements as described above with reference to the third example:

### GET

http://www.example.com/sample.mpd? Info=true&ETag=F561F4415CFE67AABDC5C597EA79419E& XPath=/MPD/*/AdaptationSet[@mimeType=“video/mp4”]/Representation[@codecs=“mvc1.760028”]

In that case there are two Periods and only Period 2 has updated elements. Table 11 illustrates an example of an information patch informing the client apparatus that a video Representation was added to Adaptation Set 5 while another one was removed from Adaptation Set 8, the response may comprise a patch that will I:

TABLE 11
<?xml version=″1.0″ encoding=″UTF-8″?>
<infodiff>
<added sel=MPD[@publishTime=″2015-07-25T12:38:12Z″]/
Period[@id=″2″]/AdaptationSet[@id=″5″]> <Representation id=″C5_3″
bandwidth=192000″
codecs=″avc1.640828″>
</added>
<removed sel=MPD[@publishTime=″2015-07-25T12:38:12Z″]/
Period[@id=″2″]/AdaptationSet[@id=″8″]>
<Representation id=″C8_4″ bandwidth=″512000″ codecs=″mvc1.760028″>
</removed>
</infodiff>

The request may be an information patch request with multiple ETag, XPath pairs as described above with reference to the fifth example:

### GET

http://www.example.com/sample.mpd?Info=true&ETag=0D7042536D65AA3C8FF40A788A060D18&X Path=/MPD/Period[@id=“1”]/AdaptationSet[@id=“1”]&ETag=F561F4415CFE67AABDC5C597EA79419E&XPath=/MPD/Period[@start=“PT0.00S”]/AdaptationSet[@id=“2”]

In that case, the server may decide (depending on the implementation) to send a response comprising a composite patch, wherein each patch may relate to a specific ETag, XPath pair. Table 12 depicts an example of such composite patch:

TABLE 12
<?xml version=″1.0″ encoding=″UTF-8″?>
<infodiff>
<added sel=MPD[@publishTime=″2015-07-25T12:38:12Z″]/
Period[@id=″1″]/AdaptationSet[@id=″2″]> <Representation id=″C2_3″
bandwidth=″192000″
codecs=″avc1.640828″>
</added>
</infodiff>
<infodiff>
<removed sel=MPD[@publishTime=″2015-07-25T12:40:12Z″]/
Period[@id=″1″]/AdaptationSet[@id=″1″]>
<Representation id=″C1_4″ bandwidth=″512000″ codecs=″mvc1.760028″>
</removed>
</infodiff>

In this example the PublishTime of the reference MPD is different in the two subpatches because the first subpatch refers to an older MPD than the second subpatch.

Generally, as described above, patch responses may have different formats. Examples of such different formats include:
a response starting with tag <MPD> signalling the client apparatus that the response comprises a complete MPD;
a responses starting with tag <diff> signalling the client apparatus that the response comprises an personalized patch;
a response starting with tag <infodiff> signalling the client apparatus that the response comprises an information patch.

Rules for parsing and interpreting these responses are described below.

Responses starting with a <MPD> tag are returned when the server determines (in response to a patch request) to send the full MPD. In that case, the client apparatus will just need to replace its current version with the one received by the server.

In an embodiment, a responses message starting with a <diff> tag may signal the client apparatus that it contains an update patch. Update patches may be either atomic or composite. In case of a composite patch, the patch may comprise a plurality of <diff> tags in the document. Composite patches need to be applied sequentially. The publishTime attribute used to identify the target MPD in the patch text may not correspond to the PublishTime attribute in the MPD present at the client apparatus (this is always the case from the second (sub)patch onwards in a composite patch). This may be due to the fact that the manifest file is not being updated entirely with a patch. The client apparatus should ignore this attribute and apply the patch nevertheless.

In an embodiment where the MPD parts at different versions are tracked by means of the publishTime of the MPD version they were taken from (instead of the ETag), the client may check whether the publishTime attribute used to identify the target MPD in each patch instruction is equal to the publishTime that tracks that specific MPD part at the client, before applying the patch.

Responses starting with a <infodiff> tag signal the client apparatus that they contain information patch. Information patches may be atomic or composite. In the latter case the document may comprise a plurality of <infodiff> tags. As in the case of update patches, the PublishTime attribute used to identify the target MPD in the patch text may not correspond to the PublishTime attribute in the MPD present at the client.

The client apparatus may use the information obtained on the basis of an information patch to subsequently request an update patch.

The capability of a server to support update patch requests, information patch requests, or both, may be indicated in the MPD by means of adding a personalized patch element to the MPD (which may be placed directly under the root MPD element). Table 13 provides an exemplary syntax of the personalized patch element:

TABLE 13

| Element | Description |
|---|---|
| PersonalisedPatch | If present, specifies the URI where |
| | personalised patch can be requested |
| @version | Specifies the version of the selective |
| | update mechanism supported by the |
| | server. Version “1.0” supports all |
| | capabilities described in the present |
| | document. |
| @type | If present, specifies the type of patch |
| | supported, which can either be “streaming” |
| | or “information”. |
| | If absent, it means that the server supports |
| | both types of patch. |

Table 14 illustrates a snippet of a manifest file comprising Personalised Patch elements for signaling the client apparatus that the server supports both streaming and information patches:

```
TABLE 14
<?xml version=″1.0″ encoding=″UTF-8″?>
<MPD
  xmlns:xsi=″http://www.w3.org/2001/XMLSchema-instance″
  xmlns=″urn:mpeg:dash:schema:mpd:2011″
  xsi:schemaLocation=″urn:mpeg:dash:schema:mpd:2011 DASH-MPD.xsd″
  type=″dynamic″
  minimumUpdatePeriod=″PT3S″
  availabilityStartTime=″2015-07-25T12:30:00″
  minBufferTime=″PT6.00S″
  publishTime=″2015-07-25T12:38:12Z″
  profiles=″urn:mpeg:dash:profile:isoff-main:2011″>
  <BaseURL>http://www.example.com/</BaseURL>
  <PersonalisedPatch version=″1.0″>http://cdn1.example.com/sample.MPD</PersonalisedPatch>
  <PersonalisedPatch type=″update″
version=″1.0″>http://cdn2.example.com/sample.MPD</PersonalisedPatch>
  <PersonalisedPatch type=″information″
version=″1.0″>http://cdn3.example.com/sample.MPD</PersonalisedPatch>
  <!-- In this Period there are 3 views, coming from three lined up cameras: C1-C2-C3. -->
  <Periodstart=″PT0.00S″ duration=″PT2000.00S″ id=″1″>
  ...
  </Period>
  </MPD>
```

In the embodiments described with reference to the figures, ETags are used wherein the patch is identified on the basis of a hash of the whole MPD. In another embodiment, however, the hash may be calculated on the basis of a part of the MPD. In yet another embodiment, the hash may be calculated on the PublishTime attribute of the MPD.

The publishTime attribute is always contained in the MPD. In an embodiment, the new publishTime attribute value may be appended to the patch itself, so that the client apparatus may use it as an identifier of the MPD. In a further embodiment, the hash of the MPD may be inserted in the MPD or appended thereto.

Further, in the embodiments described with reference to the figures, an personalized patch may be determined on the basis of “diff” documents that are also used in the standard patch mechanism as defined in the MPEG DASH standard. This allows the personalized patch mechanism to be compatible with the standard patch mechanism.

However, a patch may also be defined as a subpart of the MPD. This has the advantage of requiring less effort for both the client apparatus, which does not need to keep track of different versions of the different parts of the MPD. Similarly, the server does not need to compute a difference between two manifest versions but can directly take “a piece” from the newest one. For example, the modification requested in example 1 above may be requested using the following format:

### GET

http://www.example.com/sample.mpd?XPath=/MPD/Period[@start=“PT0.00S”]/AdaptationSet[@id=“1”]

In this embodiment, the identifier of the MPD version currently used by the client (e.g. in the form of an ETag) is not included in the request. This request may signal the server to determine and return a “subpart” of the most recent version of the manifest file named sample.mpd, wherein the subpart may include one or more metadata elements of the manifest file, in this example all C1_1 Adaptation Sets. Hence, in this example there is no need to provide to the server information about which version the client apparatus has.

Table 15 provides a subpart of the MPD that is listed in Table 1B:

TABLE 15
<?xml version=″1.0″ encoding=″UTF-8″?>
<subpart sel=″MPD[@publishTime=″2015-07-
25T12:43:12Z″]/Period[@id=″1″]/AdaptationSet[@id=″1″]><Representation id=″C1_1″
bandwidth=″128000″ codecs=″avc1.640828″><SegmentList duration=″3″><SegmentURL
media=″seg-m1-C1_1view-1.mp4″/><SegmentURL media=″seg-m1-C1_1view-
2.mp4″/><SegmentURL media=″seg-m1-C1_1view-3.mp4″/><SegmentURL media=″seg-m1-
C1_1view-4.mp4″/><SegmentURL media=″seg-m1-C1_1view-5.mp4″/><SegmentURL media=″seg-
m1-C1_1view-6.mp4″/><SegmentURL media=″seg-m1-C1_1view-
7.mp4″/></SegmentList></Representation>
<Representation id=″C1_2″ bandwidth=″512000″ codecs=″mvc1.760028″><SegmentList
duration=″3″><SegmentURL media=″seg-m1-C1_2view-1.mp4″/><SegmentURL media=″seg-m1-
C1_2view-2.mp4″/><SegmentURL media=″seg-m1-C1_2view-3.mp4″/><SegmentURL media=″seg-
m1-C1_2view-4.mp4″/><SegmentURL media=″seg-m1-C1_2view-5.mp4/><SegmentURL
media=″seg-m1-C1_2view-6.mp4″/><SegmentURL media=″seg-m1-C1_2view-
7.mp4″/></SegmentList></Representation>
</subpart>

In a further embodiment, the client apparatus may send a request for a partial update of the manifest file in the form of a so-called Server And Network Assisted DASH (SAND) message. The Server and network assisted DASH protocol is part of the MPEG DASH standard, whose latest publicly available version is “Information Technology—Dynamic adaptive streaming over HTTP (DASH)—Part 5: Server and network assisted DASH (SAND)”, ISO/IEC FDIS 23009-5:2016(E) of June 2016, which is hereby incorporated by reference into this application.

The client apparatus may use a SAND status message to send a request for a modification of the manifest file to the DANE (i.e. the DASH Aware Network Element). It may be assumed that the DANE @endpoint may be defined as follows: @endpoint=http://dane1.example.com/sand_messages.

In this scenario, if the client wishes to request a modification of manifest file, e.g. on the basis of a modification patch, it may send an HTTP POST message with the following header:

POST /sand_messages HTTP/1.1
Host: dane1.example.com
Content-Type: application/sand+xml;charset=″utf-8″
[...]

Here, the Host name and POST path correspond to the @endpoint as mentioned above. In order to send an update patch, e.g. a modification patch, in the body of this HTTP

POST message, a new scheme may be defined, urn:mpeg:dash:schema:sandmessage:2017, supporting the new SAND status message: PersonalizedPatch. This message may include the parameters described in table 16 below:

TABLE 16
PersonalizedPatch parameters

| Parameter | Type | Cardinality | Description |
|---|---|---|---|
| PersonalizedPatchList | object | 1 | Contains a list of elements forming the |
| | | | patch request |
| PersonalizedPatch | entry | 1 . . . N | Contains a patch request for a certain |
| | | | subpart of the MPD available at a certain |
| | | | version at the client |
| mpd | string | 1 | The name of the MPD for which a patch is |
| | | | requested |
| version | string | 1 | The version of the part of the MPD, for |
| | | | which the patch is requested, available at |
| | | | the client |
| xpath | string | 1 | The XPath (XML Path Language) indicating |
| | | | the part of the MPD for which the patch is |
| | | | requested |

To request an update of Representation C1_1 of Adaptation Set 1 of Period 1 of the manifest file “sample.mpd”, of which the client holds a version identified by an ETag with value “F561F4415CFE67AABDC5C597EA79419E”, then the body of the HTTP POST message of the update patch requested by the client may look as follows:

```
<?xml version=′1.0′ encoding=′UTF-8′?>
<SANDMessage xmlns=′urn:mpeg:dash:schema:sandmessage:2017′ senderId=′client1234′
generationTime=′2016-11-21T11:20:52-08:00′>
  <PersonalizedPatchList messageId=′1234′>
    <PersonalizedPatch mpd=′sample.mpd′
version=′ETag=F561F4415CFE67AABDC5C597EA79419E′
xpath=′/MPD/Period[@id=″1″]/AdaptationSet[@id=″1″]/Representation[@id=″C1_1″]′>
    </Personalized Patch>
  </Personalized PatchList>
</SANDMessage>
```

Upon receipt of a request for an update patch, the DANE may send a new PER message to the client, PersonalizedPatchContent, containing the patch. This message, which is also defined in the new scheme, urn:mpeg:dash:schema:sandmessage:2017, may have the parameters described in table 17 below:

TABLE 17
PersonalizedPatchContent parameters

| Parameter | Type | Cardinality | Description |
|---|---|---|---|
| Personalized PatchContentList | object | 1 | Contains a list of elements forming |
| | | | the patch response |
| PersonalizedPatchContent | entry | 1 . . . N | Contains a patch for a certain |
| | | | subpart of the MPD available at a |
| | | | certain version at the client |
| mpd | string | 1 | The name of the MPD for which a |
| | | | patch is for |
| version | string | 1 | The version of the part of the MPD, |
| | | | for which the patch is provided, |
| | | | available at the client |
| xpath | string | 1 | The XPath (XML Path Language) |
| | | | indicating the part of the MPD for |
| | | | which the patch is for |

The PER message comprising the requested update patch may then look as follows:

```
<?xml version=′1.0′ encoding=′UTF-8′?>
<SANDMessage xmlns=′urn:mpeg:dash:schema:sandmessage:2017′ senderId=′dane1234′
generationTime=′2016-11-21T11:20:52-08:00′>
  <PersonalizedPatchContentList messageId=′4321′>
    <PersonalizedPatchContent mpd=′sample.mpd′
version=′ETag=F561F4415CFE67AABDC5C597EA79419E′
xpath=′/MPD/Period[@id=″1″]/AdaptationSet[@id=″1″]/Representation[@id=″C1_1″]′>
      <diff>
        <add sel=′MPD[@publishTime=″2015-07-
25T12:30:09Z″]/Period[@id=″1″]/AdaptationSet[@id=″1″]/Representation[@id=″C1_1″]/SegmentList′>
          <SegmentURL media=′seg-m1-C1_1view-4.mp4′/><SegmentURL media=′seg-m1-
C1_1view-5.mp4′/></add>
      </diff>
    </PersonalizedPatchContent>
  </PersonalizedPatchContentList>
</SANDMessage>
```

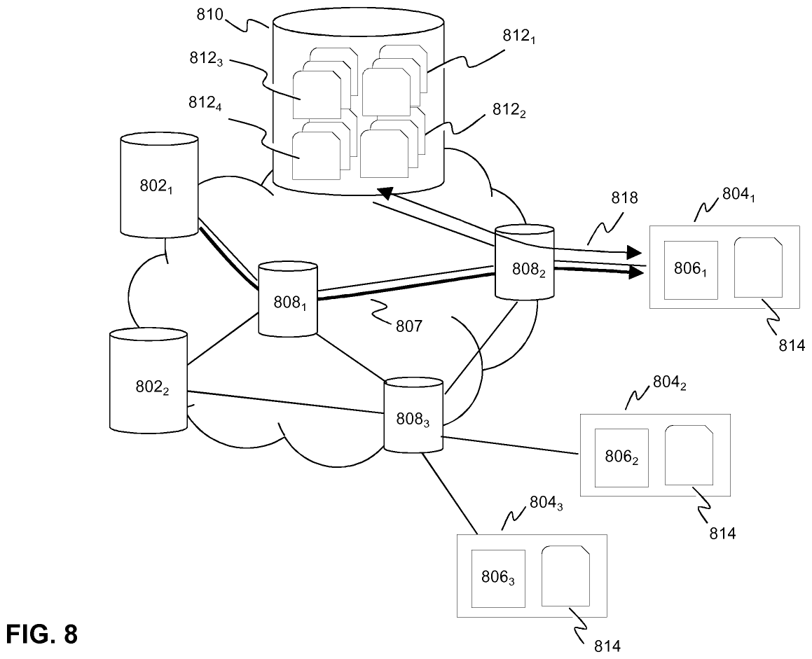

FIG. 8 schematically depicts a media delivery system for streaming media data to a client apparatus according to a further embodiment of the invention. In particular, FIG. 8 depicts a media delivery system that is similar to the system described with reference to FIG. 1.

The system may comprise one or more media sources 802_{1, 2}, configured to stream media data using a suitable streaming to media processing devices 804₁₋₃. A media processing device may comprise a client apparatus 806₁₋₃ configured for requesting media data from the one or more media servers in the network using a manifest file. A media server may transmit media data 807 via one or more network nodes 808₁₋₃ (proxies, caches, etc.) to a client apparatus using an adaptive streaming techniques.

A client apparatus 806₁₋₃ associated with a media processing device 804₁₋₃ may be configured to determine and/or select one or more specific parts, e.g. one or more metadata elements (e.g. MPD elements such as Periods, Adaptation Sets, Representations and/or MPD attributes associated with codecs, resolution, etc.) of the manifest file 814 it is currently using and to request an update for these selected parts of the manifest file. A client apparatus may send a request message to a manifest file server 810 which is configured to generate new versions of the dynamic manifest file each client apparatus is using.

In this particular embodiment however the manifest file server is further configured to generate one or more modified versions of the manifest file 812₁₋₄. For example, beside the new versions of a dynamic manifest file (e.g. of a live streaming session) that includes all Adaptation Sets that are theoretically available for a client apparatus, the server may also start a server instance that is configured to generate selectively updated versions of the dynamic manifest file used by the client.

The selectively updated versions of the dynamic manifest file are updated only with respect to segment identifiers associated with a subset of metadata elements selected by the client apparatus (e.g. segment identifiers associated with Adaptation Sets and/or Representations defining content that requires low bandwidth availability and/or a specific codec that the client device supports.

The request message comprising the manifest file identifier and one or more metadata elements of the dynamic manifest file the client apparatus is using, may trigger the manifest file server to generate location information in the form of address information, e.g. an URL, that enables the client apparatus to retrieve selectively updated versions of the dynamic manifest file that are generated by the server instance. In an embodiment, the request message may further comprise one or more version identifiers of the one or more metadata elements in the request message.

The client apparatus may receive the address information in a response message and use the address information to request the server to send a selectively updated version of the dynamic manifest file. After having received the selectively updated version of the manifest file, the client apparatus may start requesting segments on the basis of the segment identifiers in the manifest file, which in this case may be modified for low bandwidth use.

Hence, in this embodiment, the manifest file server may start different server instances wherein each server instance is configured to publish a selectively updated version of the dynamic manifest file. The client apparatus may select a particular variant in accordance with its own needs by sending a request a request for a partial update to the manifest file server. Once the client apparatus has selected a particular variant it may continue the live-streaming session on the basis of newly published versions of the selected manifest file, which is a modified version of the main manifest file.

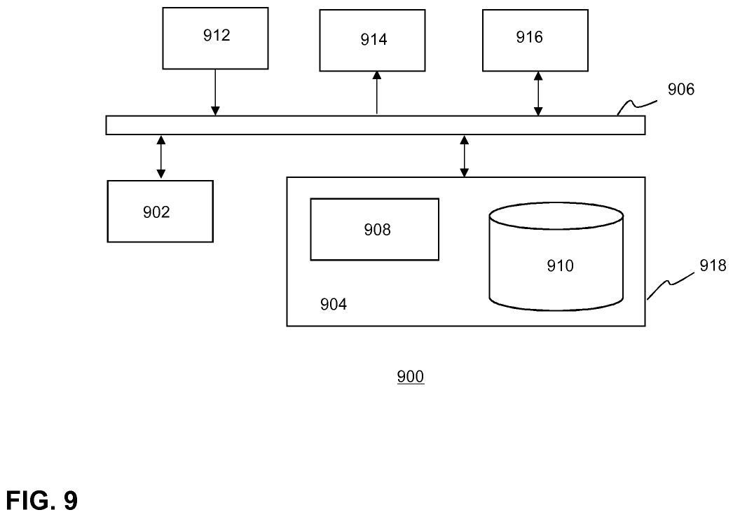

FIG. 9 is a block diagram illustrating an exemplary data processing system that may be used in as described in this disclosure. Data processing system 900 may include at least one processor 902 coupled to memory elements 904 through a system bus 906. As such, the data processing system may store program code within memory elements 904. Further, processor 902 may execute the program code accessed from memory elements 904 via system bus 906. In one aspect, data processing system may be implemented as a computer that is suitable for storing and/or executing program code. It should be appreciated, however, that data processing system 900 may be implemented in the form of any system including a processor and memory that is capable of performing the functions described within this specification.

Memory elements 904 may include one or more physical memory devices such as, for example, local memory 908 and one or more bulk storage devices 910. Local memory may refer to random access memory or other non-persistent memory device(s) generally used during actual execution of the program code. A bulk storage device may be implemented as a hard drive or other persistent data storage device. The processing system 800 may also include one or more cache memories (not shown) that provide temporary storage of at least some program code in order to reduce the number of times program code must be retrieved from bulk storage device 910 during execution.

Input/output (I/O) devices depicted as input device 912 and output device 914 optionally can be coupled to the data processing system. Examples of input device may include, but are not limited to, for example, a keyboard, a pointing device such as a mouse, or the like. Examples of output device may include, but are not limited to, for example, a monitor or display, speakers, or the like. Input device and/or output device may be coupled to data processing system either directly or through intervening I/O controllers. A network adapter 916 may also be coupled to data processing system to enable it to become coupled to other systems, computer systems, remote network devices, and/or remote storage devices through intervening private or public networks. The network adapter may comprise a data receiver for receiving data that is transmitted by the systems, devices and/or networks to the data and a data transmitter for transmitting data to the systems, devices and/or networks. Modems, cable modems, and Ethernet cards are examples of different types of network adapter that may be used with data processing system 950.

As pictured in FIG. 9, memory elements 904 may store an application 918. It should be appreciated that data processing system 900 may further execute an operating system (not shown) that can facilitate execution of the application. Application, being implemented in the form of executable program code, can be executed by data processing system 800, e.g., by processor 902. Responsive to executing application, data processing system may be configured to perform one or more operations to be described herein in further detail.

In one aspect, for example, data processing system 900 may represent a client data processing system. In that case, application 918 may represent a client application that, when executed, configures data processing system 900 to perform the various functions described herein with reference to a “client” or “a client apparatus”. Examples of a client apparatus can include, but are not limited to, a personal computer, a portable computer, a mobile phone, or the like.

In another aspect, data processing system may represent a server. For example, data processing system may represent an (HTTP) server, e.g. a media server or a manifest file server, in which case application 918, when executed, may configure data processing system to perform (HTTP) server operations. In another aspect, data processing system may represent a module, unit or function as referred to in this specification.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for selectively updating a dynamic manifest file, the dynamic manifest file being used by a client apparatus for retrieving segmented content, said segmented content comprising segments referenced by segment identifiers of said dynamic manifest file, the manifest file comprising metadata elements associated with a set of representations of the segmented content, each representation being associated with a plurality of segment identifiers, each segment identifier identifying a segment associated with a predetermined playout time, the dynamic manifest file being associated with a manifest file identifier, the method comprising:
the client apparatus selecting one or more metadata elements of the manifest file, the one or more selected metadata elements being associated with a subset of representations of the set of representations defined in the manifest file;
the client apparatus transmitting a request message identifying the selected one or more metadata, and, optionally, said manifest file identifier, to a network node, the request message being configured to trigger the network node to generate a response message on the basis of the information in the request message; and,
the client apparatus receiving the response message from the network node,
wherein the response message comprises:
location information for retrieving a selectively updated version of the dynamic manifest file used by the client, wherein the selectively updated version only comprises new segment identifiers associated with the one or more selected metadata elements; or, wherein the response message comprises:
update information configured to selectively update the dynamic manifest file used by the client apparatus, wherein the update information only comprises new segment identifiers associated with the one or more selected metadata elements.

2. Method according to claim 1, wherein if the response message comprises update information, the method further comprising:
the client apparatus selectively updating the dynamic manifest file it is using on the basis of the update information, the updating including:
replacement of segment identifiers in the dynamic manifest file with new segment identifiers identified in the update information; and/or,
addition of new segment identifiers, and optionally, one or more new metadata elements identified in the update information to the dynamic manifest file.

3. Method according to claim 1, wherein if the response message comprises location information, the method comprising:
using the location information to request a network node to transmit a selectively updated version of the dynamic manifest file to the client apparatus;
the client apparatus receiving the selectively updated version of the dynamic manifest file and replacing the dynamic manifest file used by the client apparatus with the selectively updated version.

4. Method according to claim 1, wherein the manifest file is configured as a Media Presentation Description, MPD, the metadata associated with the set of representations of the segmented content including one or more Periods; one or more Adaptation Sets; and/or, one or more Representations and wherein the client apparatus is a HAS client apparatus configured to support the MPEG-DASH protocol.

5. Method according to claim 1 wherein the network node is a manifest file server configured to generate new versions of the dynamic manifest file used by the client apparatus, each new version of the dynamic manifest file being identified by a time-based identifier associated with the publication of the manifest file version by the network node; or, a hash-based identifier determined on the basis of at least part of the content of the manifest file.

6. Method according to claim 2 further comprising:
the client apparatus storing one or more metadata element identifiers and version information in a memory, the stored one or more metadata element identifiers identifying one or more metadata elements that are selectively updated by said client apparatus, the version information being associated with one or more versions of the manifest file published by the network node, wherein the network node constructed the update information on the basis of the one or more published versions.

7. Method according to claim 1 wherein the request message and the response message are each configured as a HTTP message, the one or more metadata elements and, optionally, the manifest file identifier in the request message being configured as a URI query string in the HTTP message.

8. Method according to claim 1 wherein the request message and the response message are each configured as a Server And Network Assisted DASH, SAND, message; and/or,
wherein the dynamic manifest file comprises an indicator for signalling the client apparatus that the network node supports SAND messages for requesting selectively updating one or more metadata elements of the dynamic manifest file.

9. Method according to claim 1, wherein the one or more metadata elements are selected on the basis of capability information of the client apparatus and/or capability information of a media processing device on which the client apparatus is implemented; or, wherein the one or more metadata elements are selected on the basis of user input; or, wherein the one or more metadata elements are selected on the basis of metrics generated by the client apparatus or by a network node.

10. Method according to claim 1 wherein the one or more metadata elements are selected in response to a trigger signal, the trigger signal being generated on the basis of a timer period, the timer period being defined in the dynamic manifest file.

11. Method according to claim 1 wherein the dynamic manifest file comprises manifest file server capabilities information, the manifest file server capabilities information signalling the client apparatus that the network node is adapted to receive a request message comprising at least the one or more selected metadata elements and, optionally, version information associated with the one or more selected metadata elements, the request message being configured to trigger the network node to generate update information associated with the one or more selected metadata elements in the request message.

12. Method according to claim 1, wherein the location information comprises address information associated with a network node that is configured to store one or more selectively updated versions of the dynamic manifest file used by the client on the basis of the information in the request message.

13. A server apparatus comprising:
a computer readable storage medium having computer readable program code embodied therewith, and a processor coupled to the computer readable storage medium, wherein, the processor, responsive to executing the computer readable program code, is configured to perform executable operations, the executable operations comprising:
receiving a request message from a client apparatus, the request message identifying a manifest file identifier, whereby the manifest file identifier identifies a dynamic manifest file,
wherein the dynamic manifest file is used by the client apparatus for retrieving segmented content, said segmented content comprising segments referenced by segment identifiers of said dynamic manifest file, the dynamic manifest file comprising metadata elements associated with a set of representations of the segmented content, each representation being associated with a plurality of segment identifiers, each segment identifier identifying a segment associated with a predetermined playout time; and,
wherein the request message further identifies one or more metadata selected by the client apparatus, the one or more metadata being associated with a subset of representations of the set of representations defined in the dynamic manifest file the client apparatus is using;
determining or receiving new segment identifiers associated with the one or more selected metadata;
forming a selectively updated version of the dynamic manifest file the client apparatus is using, the selectively updated version only comprising new segment identifiers associated with the subset of representations;
transmitting a response message to the client apparatus, the response message comprising location information for retrieving the selectively updated version of the dynamic manifest file;
or, the executable operations comprising:
receiving a request message comprising a manifest file identifier identifying a dynamic manifest file,
wherein the dynamic manifest file being used by a client apparatus, for retrieving segmented content, said segmented content comprising segments referenced by segment identifiers of said dynamic manifest file, the dynamic manifest file comprising metadata elements associated with a set of representations of the segmented content, each representation being associated with a plurality of segment identifiers, each segment identifier identifying a segment associated with a predetermined playout time; and,
wherein the request message further identifies one or more metadata selected by the client apparatus, the one or more metadata being associated with a subset of representations of the set of representations defined in the dynamic manifest file the client is using;
determining or receiving new segment identifiers associated with the one or more selected metadata;
forming update information configured to selectively update the dynamic manifest file used by the client apparatus, wherein the update information only comprises new segment identifiers associated with the one or more selected metadata elements;
transmitting a response message to the client apparatus, the response message comprising update information triggering the client apparatus to selectively the manifest file it is using, wherein the new segment identifiers are segment identifiers not yet present at the client apparatus prior to receiving said response message.

14. A client apparatus configured to selectively update a dynamic manifest file, the dynamic manifest file being used by the client apparatus for retrieving segmented content, said segmented content comprising segments referenced by segment identifiers of said dynamic manifest file, the dynamic manifest file comprising metadata elements associated with a set of representations of the segmented content, each representation being associated with a plurality of segment identifiers, each segment identifier identifying a segment associated with a predetermined playout time, the dynamic manifest file being associated with a manifest file identifier, the client apparatus comprising:
a computer readable storage medium having at least part of a program embodied therewith, the computer readable storage medium comprising the dynamic manifest file;
and, a computer readable storage medium having computer readable program code embodied therewith, and a processor coupled to the computer readable storage medium, wherein the processor is configured to, responsive to executing the computer readable program code, perform executable operations comprising:
selecting one or more metadata elements of the dynamic manifest file, the one or more selected metadata elements being associated with a subset of representations of the set of representations defined in the dynamic manifest file;
transmitting a request message comprising information identifying the selected one or more metadata elements, and, optionally, said manifest file identifier, to a network node, the request message being configured to trigger the network node to generate a response message on the basis of the information in the request message; and,
receiving the response message from the network node, wherein the response message comprises:
location information for retrieving a selectively updated version of the dynamic manifest file used by the client, wherein the selectively updated version only comprises new segment identifiers associated with the one or more selected metadata elements; or, wherein the response message comprises:
update information configured to selectively update the dynamic manifest file used by the client apparatus, wherein the update information only comprises new segment identifiers associated with the one or more selected metadata elements,
wherein the new segment identifiers are segment identifiers not yet present at the client apparatus prior to receiving said response message.

15. Non-transitory computer-readable storage media comprising a dynamic manifest file for a client apparatus the dynamic manifest file comprising computer readable program code, the computer readable program code comprising:
a manifest file version identifier;
metadata elements associated with a set of representations of segmented content, each representation being associated with a plurality of segment identifiers, each segment identifier identifying a segment associated with a predetermined playout time; and,
server capabilities information, the server capabilities information signalling the client apparatus that a server is adapted to receive a request message from the client apparatus and adapted to send a response message to the client apparatus, the request message comprising one or more metadata elements of the dynamic manifest file the client apparatus is using, the one or more metadata elements being selected by the client apparatus, and a manifest file identifier of the dynamic manifest file used by the client apparatus, the request message being configured to trigger the server to:
generate update information for a client apparatus, the update information enabling the client apparatus to selectively update the dynamic manifest file used by the client apparatus, wherein the update information only comprises new segment identifiers associated with the one or more selected metadata elements, or
generate location information for enabling the client apparatus to retrieve a selectively updated version of the dynamic manifest file used by the client apparatus;
and, to transmit the update information or location information in a response message to the client apparatus.

16. Computer program product comprising software code portions configured for, when run in the memory of a computer, executing the method according to claim 1.
